(19) United States
(12) Patent Application Publication
(10) Pub. No.: US 2026/0129469 A1
(43) Pub. Date: May 7, 2026

(54) Floor-Level Allocation of Network Devices

(71) Applicant: Cisco Technology, Inc., San Jose, CA (US)

(72) Inventors: Audrey Yazdan, RICHFIELD, OH (US); Brian Hart, Sunnyvale, CA (US); Peiman Amini, Fremont, CA (US); Nick Schnorr, MILPITAS, CA (US); Rabe Arshad, MILPITAS, CA (US)

(21) Appl. No.: 18/939,877

(22) Filed: Nov. 7, 2024

(51) Int. Cl. H04W 16/20; H04W 8/00; H04W 24/02

(52) U.S. Cl. CPC H04W 16/20; H04W 8/005; H04W 24/02

(57) ABSTRACT

Devices and methods for floor-level allocation of network devices, for example, access points, are provided. A controller, coupled to multiple switches disposed across one or more floors in a space, receives discovery data and signal data. The discovery data, for example, connectivity discovery protocol data, indicates an association of the switches and multiple access points connected thereto and deployed across the floor(s). The signal data, for example, received signal strength indicator data, is associated with the set of access points. The controller classifies the access points into a set of clusters based on the discovery data and the signal data. The controller determines a sequence of the floors based on the clusters and allocates a floor-level identifier to the access points based on the sequence. The devices and methods optimize indoor localization, for example, in environments where environmental data such as air pressure data may be unreliable or unavailable.

The present disclosure relates to wireless communication networks. More particularly, the present disclosure relates to floor-level allocation of network devices, for example, access points.

### BACKGROUND

The proliferation of smartphones has spurred various location-based services, primarily aimed at positioning, for example, indoor positioning. Indoor positioning may involve determining the location of a user or a device within an indoor area or an enclosed space, for example, a building. Indoor positioning within buildings may have substantial applications across various sectors, for example, for emergency response and rescue operations, health management, disaster management, building management, surveillance, or the like. There may be an increasing demand for accurate and real-time indoor positioning, for example, for in-building navigation, asset and personnel tracking, message delivery, emergency support, or the like. While most indoor positioning studies may focus on determining a horizontal location of a user or a device within buildings, there may be a need for vertical positioning, for example, for floor-level localization in a multistory building with multiple floors. However, accurate identification of different floors in multistory buildings for precise indoor positioning in industrial and commercial applications remains a challenge.

The precision of indoor positioning and floor-level localization may be required for various applications, particularly in a building with many network devices, for example, access points. Conventional methods of indoor positioning may utilize environmental data, for example, air pressure data, for estimating vertical positions within a building. However, these methods often fail in environments where the air pressure data is incomplete, inaccurate, unreliable, or unavailable for floor-level differentiation. Further, processing a massive number of access points in a building may increase computational load and lead to potential inaccuracies in location estimation.

### SUMMARY OF THE DISCLOSURE

Devices and methods for floor-level allocation of network devices, for example, access points, and localization in accordance with embodiments of the disclosure are described herein. In many embodiments, a device may include a processor, a network interface controller configured to provide access to a network, and a memory communicatively coupled to the processor. The memory may include an allocation logic that is configured to receive discovery data and signal data. The discovery data may indicate an association of a plurality of first network devices and a plurality of second network devices connected to the plurality of first network devices. The plurality of second network devices may be deployed across one or more floors in a space. The signal data may be associated with a set of second network devices of the plurality of second network devices. The allocation logic may further be configured to classify the plurality of second network devices into a set of clusters based on the received discovery data and the received signal data, determine a sequence of the one or more floors based on the set of clusters, and allocate a floor-level identifier to at least one second network device of the plurality of second network devices based on the determined sequence.

In a number of embodiments, the plurality of first network devices may include switches configured to implement at least one of a Connectivity Discovery Protocol (CDP) or a Link Layer Discovery Protocol (LLDP).

In a variety of embodiments, the plurality of second network devices may include access points deployed across the one or more floors.

In various embodiments, the discovery data may include at least one of CDP data or LLDP data. The discovery data may include at least one of: a device name or a location identifier, of a first network device of the plurality of first network devices and a second network device of the plurality of second network devices.

In more embodiments, the signal data may include Received Signal Strength Indicator (RSSI) data.

In additional embodiments, a cluster of the set of clusters may correspond to a floor of the one or more floors.

In further embodiments, the allocation logic may further be configured to determine a number of floors in the space based on a count of clusters in the set of clusters.

In still more embodiments, the allocation logic may further be configured to perform unsupervised machine learning to classify the plurality of second network devices into the set of clusters.

In still further embodiments, prior to determining the sequence of the one or more floors, the allocation logic may further be configured to validate the set of clusters.

In still additional embodiments, the set of clusters may be validated based on a variance value between the set of clusters and a variance value within the set of clusters.

In some more embodiments, the allocation logic may further be configured to transmit an indication of the floor-level identifier allocated to the at least one second network device.

In yet various embodiments, the set of clusters may be connected by one or more weighted edges.

In yet more embodiments, the sequence of the one or more floors may be determined based on weights of the one or more weighted edges.

In still yet more embodiments, the allocation logic may further be configured to receive new discovery data and new signal data, update the set of clusters based on the new discovery data and the new signal data, determine that a first count of clusters in the updated set of clusters is different from a second count of clusters in the set of clusters, and update the sequence of the one or more floors based on the determination that the first count of clusters is different from the second count of clusters.

In many further embodiments, the allocation logic may further be configured to allocate a new floor-level identifier to the at least one second network device based on the updated sequence.

In many additional embodiments, an access point may include a processor, a network interface controller configured to provide access to a network, and a memory communicatively coupled to the processor. The memory may include an allocation logic that is configured to transmit signal data and discovery data and receive a floor-level identifier allocation based on the transmitted signal data and the transmitted discovery data. The discovery data may indicate an association of a switch, the access point, and a plurality of other access points that are deployed across one or more floors in a space.

In still yet further embodiments, the signal data may include RSSI data associated with the plurality of other access points, and the discovery data may include at least one of CDP data or LLDP data.

In still yet additional embodiments, the access point and the plurality of other access points may be connected to a set of switches that provide the discovery data.

In several embodiments, a method for floor-level allocation of network devices may include receiving discovery data and signal data. The discovery data may indicate an association of a plurality of first network devices and a plurality of second network devices connected to the plurality of first network devices. The plurality of second network devices may be deployed across one or more floors in a space. The signal data may be associated with a set of second network devices of the plurality of second network devices. The method for floor-level allocation of network devices may further include classifying the plurality of second network devices into a set of clusters based on the received discovery data and the received signal data, determining a sequence of the one or more floors based on the set of clusters, and allocating a floor-level identifier to at least one second network device of the plurality of second network devices based on the determined sequence.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a block diagram of a system implemented in an indoor space including multiple floors with access points connected to corresponding switches in accordance with various embodiments of the disclosure;

FIG. 2 is a schematic diagram illustrating an unsupervised machine learning method for floor-level allocation of network devices in accordance with various embodiments of the disclosure;

FIG. 3 is a schematic diagram illustrating various subsets of artificial intelligence in accordance with various embodiments of the disclosure;

FIG. 4 is a block diagram illustrating different methods of machine-based learning in accordance with various embodiments of the disclosure;

FIG. 5 is a block diagram illustrating a machine learning lifecycle in accordance with various embodiments of the disclosure;

FIG. 6 is a schematic diagram illustrating an exemplary neural network in accordance with various embodiments of the disclosure;

FIG. 7 is a flowchart depicting a process for floor-level allocation of network devices in accordance with various embodiments of the disclosure;

FIG. 8 is a flowchart depicting a process for iterative floor-level allocation of network devices in accordance with various embodiments of the disclosure;

FIG. 9 is a flowchart depicting a process for classifying multiple access points into a set of clusters in accordance with various embodiments of the disclosure;

FIG. 10 is a flowchart depicting a process for executing one or more operations based on floor-level allocation of network devices in accordance with various embodiments of the disclosure; and

FIG. 11 is a conceptual block diagram of a device capable of executing components and an allocation logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, devices and methods are discussed herein for floor-level allocation of network devices, for example, access points, and localization. Floor-level allocation may refer to designating or mapping access points to different floors within an indoor environment or an enclosed space, for example, a building. Localization, for example, indoor localization may refer to determining a physical location of a user or a device in an indoor environment. In many embodiments, the devices and methods discussed herein may perform floor-level allocation and localization within a building with multiple access points, without relying on environmental data such as air pressure data that may be incomplete, inaccurate, unreliable, or unavailable for floor-level differentiation. In a number of embodiments, the devices and methods discussed herein may integrate and utilize signal data such as Received Signal Strength Indicator (RSSI) data from access points and discovery data such as Connectivity Discovery Protocol (CDP) data, Link Layer Discovery Protocol (LLDP) data, or the like from switches and access points, and classify floors based on a connectivity weight between the access points of each pair of adjacent switches. RSSI may refer to a measurement of a power level or signal strength of a received radio signal. RSSI data may refer to data indicative of strength of signals transmitted by the access points and received by user devices, also referred to as “client devices”. The RSSI data may allow the client devices to determine the quality of their connections with the access points, assess their proximity to the access points, and make decisions about network connectivity or roaming. CDP data may refer to data associated with all access points connected to the switches. The CDP data may include, for example, Cisco® discovery protocol data such as device identifiers, port information, hold times, platform, management addresses, Cisco-specific capabilities, software version, Virtual Local Area Network (VLAN) information, connection mode, or the like. The LLDP data may include, for example, device identifiers, port information, Time-to-Live (ToL) information, system information, supported power, protocol-specific data, or the like.

Further, the discovery data may include, for example, a device name or a location identifier such as an Internet Protocol (IP) address, of each access point connected to each switch deployed across the floors of a building. In further examples, the discovery data may include a device name or a location identifier such as an IP address of each switch deployed across the floors of the building. In one or more embodiments, the device name may refer to a name provided by an administrator of the network device, for example, the access point or the switch. The location identifier may refer to any location-identifying numbering or string (e.g., “wiring closet X.Y”), etc. In one or more embodiments, each switch may transmit discovery data to its directly-connected access point, so that each access point may receive one set of discovery data from one switch. In further embodiments, the discovery data may include a floor-level identifier (ID) allocated to each of the access points in accordance with the present disclosure. In a variety of embodiments, the devices and methods discussed herein may correctly group even isolated access points, for example, those access points that may not appear on a connectivity RSSI list, into an appropriate floor. In various embodiments, the devices and methods discussed herein may leverage unsupervised machine learning and achieve accurate results without prior knowledge of the number of floors in a building.

Indoor positioning and floor-level localization may be performed for various applications, for example, in buildings with numerous access points. Conventional methods for indoor positioning and floor-level localization may often rely on environmental data such as air pressure data from access points, to estimate vertical positions in buildings with multiple floors and a massive number of access points, and to perform floor-level differentiation. Floor-level differentiation may refer to distinguishing and classifying different floors in an indoor environment based on various criteria including, for example, environmental data, on-board sensor data, Wi-Fi® fingerprint data, fine timing measurement data, RSSI data, device data, etc. However, the conventional methods often fail in environments where the environmental data such as air pressure data is incomplete, inaccurate, unreliable, or unavailable, which is a common scenario as not all access points may be equipped with barometric or air pressure sensors. Vertical positioning may refer to determining a position not just in two dimensions (latitude and longitude) but also in a vertical dimension (altitude or elevation). Vertical Z estimates may be influenced by various factors, and in cases where the standard floor height is not available, air pressure values may overlap, complicating the estimation process.

Moreover, air pressure data may either be unavailable or available for only a limited number of access points. Further, it may not be guaranteed that all access points on the same floor have RSSI connections. Additionally, using only RSSI data for floor-level localization for floor-level allocation and localization may be subject to fluctuations due to environmental factors such as physical obstructions and signal interference. Similarly, while CDP data may provide substantial device and network data, CDP data alone may not be sufficient for precise floor-level allocation and localization since more than one switch may be deployed per individual floor. Moreover, the presence of numerous access points can lead to an increased computational load and potential inaccuracies in location estimation. Based on these limitations and the absence of reliable air pressure data, in more embodiments, the devices and methods discussed herein may execute accurate floor identification in a space with multiple access points and optimize a localization process, without relying on environmental data such as air pressure data. Moreover, in additional embodiments, the devices and methods discussed herein may execute a localization algorithm that processes potential areas of interest within the building, which can reduce computational load. Further, in further embodiments, the devices and methods discussed herein may ensure that all access points connected to a single switch are kept within one cluster, even if some access points may not show any RSSI signal connections.

The devices and methods discussed herein may address the above-recited challenges by providing a robust and optimal method for floor-level allocation of access points and indoor localization without depending or relying on air pressure data. In still more embodiments, the devices and methods discussed herein may implement the CDP, thereby ensuring that even isolated access points, which do not appear on the RSSI list, may be correctly grouped into an appropriate floor. By keeping all access points connected to a single switch as one cluster, the devices and methods discussed herein significantly reduce false classifications for isolated access points. Moreover, by integrating RSSI data and CDP data which provide substantial connectivity information, the devices and methods discussed herein may leverage existing network infrastructure without requiring additional sensors, thereby reducing costs and simplifying deployment.

In still further embodiments, the devices and methods discussed herein may support real-time updates, making it suitable for dynamic environments where access point configurations and signal strengths may change frequently. In still additional embodiments, the devices and methods discussed herein may be scalable and adaptable to various building sizes and configurations. Further, in some more embodiments, the devices and methods discussed herein may not require prior knowledge of the number of floors, thereby increasing versatility for different applications. In yet various embodiments, the devices and methods discussed herein may handle incomplete, inadequate, unreliable, or unavailable air pressure data and account for isolated access points with no RSSI report. In yet more embodiments, the devices and methods discussed herein may not require user inputs such as the number of floors or a floor search interval, as real-time reported RSSI and CDP labels from all access points within a building are utilized to estimate the number of floors and a corresponding floor-level identifier or label for each access point.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. Nevertheless, the executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in many additional embodiments, may alternatively be embodied by or implemented as a component.

A circuit, as used herein, comprises a set of one or more electrical and/or electronic components providing one or more pathways for electric current. In still yet further embodiments, a circuit may include a return pathway for electric current, so that the circuit is a closed loop. In still yet additional embodiments, however, a set of components that does not include a return pathway for electric current may be referred to as a circuit (e.g., an open loop). For example, an integrated circuit may be referred to as a circuit regardless of whether the integrated circuit is coupled to ground (as a return pathway for electric current) or not. In several embodiments, a circuit may include a portion of an integrated circuit, an integrated circuit, a set of integrated circuits, a set of non-integrated electrical and/or electrical components with or without integrated circuit devices, or the like. In several more embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a PCB or the like. Each of the functions and/or modules described herein, in numerous embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

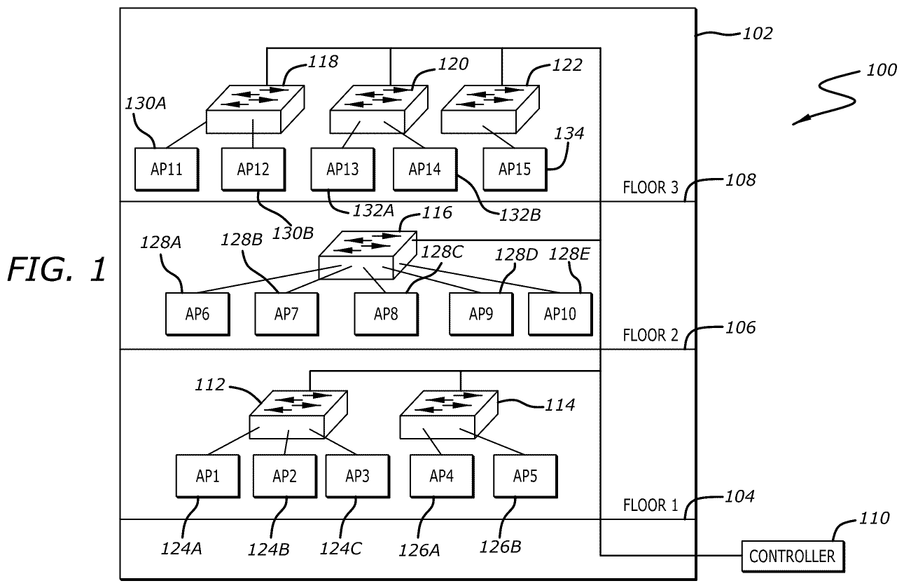

Referring to FIG. 1, a block diagram of a system 100 implemented in an indoor space including multiple floors with access points connected to corresponding switches in accordance with various embodiments of the disclosure is shown. By way of a non-limiting example, the embodiments shown in FIG. 1 illustrate an indoor space such as a multistory building 102 including three floors, for example, Floor 1 104, Floor 2 106, and Floor 3 108. Floor 1 104, Floor 2 106, and Floor 3 108 may herein collectively be referred to as “the floors 104-108”. Multiple network devices, for example, switches, access points, etc., may be deployed across the floors 104-108 of the multistory building 102. A switch may refer to a hardware network device configured to connect multiple devices, for example, computers, servers, access points, etc., within a Local Area Network (LAN), allowing the devices to communicate with each other. In an example scenario, multiple switches 112, 114, 116, 118, 120, and 122 (herein collectively referred to as the “switches 112-122”) may be deployed across the floors 104-108 of the multistory building 102 as illustrated in FIG. 1. For example, the switches 112 and 114 may be deployed on Floor 1 104, the switch 116 may be deployed on Floor 2 106, and the switches 118-122 may be deployed on Floor 3 108.

Moreover, multiple access points 124A-124C, 126A-126B, 128A-128E, 130A-130B, 132A-132B, and 134 (herein collectively referred to as the “access points 124A-134”) may also be deployed across the floors 104-108 of the multistory building 102. The access points 124A-134 may refer to network devices, for example, wireless routers, that allow wireless-capable devices, for example, client devices, to connect to a wired network. The wired network may be a wired local area network, for example, the Ethernet. The client devices may include, for example, laptops, smartphones, gaming consoles, wearable devices, other devices such as printers, Internet-of-Things (IoT) devices, or network infrastructure devices such as wireless mesh nodes, that can connect to a Wireless LAN (WLAN). The access points 124A-134 may provide wireless connectivity to the client devices and act as bridges between the WLAN and the wired network. In many embodiments, “access point” may refer to a Wi-Fi® access point (WAP), a femtocell, a hotspot, a picocell, or the like. In the above example scenario, the access points 124A-124C, 126A-126B, 128A-128E, 130A-130B, 132A-132B, and 134 may be connected to the switches 112, 114, 116, 118, 120, and 122, respectively, as illustrated in FIG. 1. For example, the access points 124A-124C may be connected to the switch 112; the access points 126A-126B may be connected to the switch 114; the access points 128A-128E may be connected to the switch 116; the access points 130A-130B may be connected to the switch 118; the access points 132A-132B may be connected to the switch 120; and the access point 134 may be connected to the switch 122.

In a number of embodiments, the switches 112-122 may be configured to implement a Connectivity Discovery Protocol (CDP). CDP may refer to a protocol, for example, the Cisco® proprietary data link layer protocol, utilized for collecting device information such as hardware, software, device name details, information about local ports, remote ports, device platform, or the like, of directly connected neighbor devices such as the access points 124A-134. In one or more embodiments, the switches 112-122 may be configured to implement a Link Layer Discovery Protocol (LLDP). LLDP may refer to a protocol that can be used by network devices to advertise or negotiate link capabilities on a network, particularly on Ethernet links, identities, capabilities, neighbors, or the like. LLDP may be implemented according to standards specified in IEEE 802.1AB, for example, or may be implemented in similar proprietary or vendor-specific protocols. For purposes of illustration, the detailed description refers to CDP as the protocol implemented by the switches, for example, the switches 112-122; however, the scope of the devices and methods discussed herein is not limited to the CDP, but may be extended to include any data link layer protocol or discovery protocol.

In a variety of embodiments, the access points 124A-134 may be CDP-enabled access points. The access points 124A-134 may transmit CDP packets, for example, in the form of multicast frames, to a destination Media Access Control (MAC) address such as 01:00:0c:cc:cc:cc, out each connected network interface. These CDP packets may be received by the switches 112-122 and other networking devices that support CDP into their connected network interfaces. The switches 112-122 may receive the CDP packets transmitted by the access points 124A-134 periodically. These CDP packets may advertise a Time-To-Live (TTL) value in seconds, which may indicate the number of seconds that the packets must be retained before they can be discarded. The switches 112-122 may process the received CDP packets and cache the device information included in each CDP packet. In various embodiments, the CDP may run on all media that support a Subnetwork Access Protocol (SNAP), including, for example, LAN, frame relay, and Asynchronous Transfer Mode (ATM) physical media. In more embodiments, the CDP may run over a data link layer only. The CDP may, therefore, allow two devices that support different network-layer protocols to learn about each other.

In additional embodiments, the switches 112-122 may be operably coupled to a controller 110, for example, a WLAN controller. The controller 110 may be a computing device configured to manage and control actions of the switches 112-122 and the access points 124A-134 deployed across the floors 104-108 in the multistory building 102, and communications therebetween. Although the controller 110 is shown as a single computing device in FIG. 1, the controller 110 may represent multiple different computing devices either physically located near the switches 112-122, or physically separate and accessed through one or more networks, for example, the Internet or a cloud. In further embodiments, the controller 110 may execute an allocation logic configured to perform floor-level allocation of the access points 124A-134 and indoor localization. The controller 110 may perform floor-level allocation and indoor localization within the multistory building 102 with multiple access points 124A-134, without relying on environmental data such as air pressure data that may be incomplete, inaccurate, unreliable, or unavailable for floor-level differentiation. In still more embodiments, floor-level differentiation may include identification of a specific floor or level within the multistory building 102, where a user or a device may be located.

The controller 110 may receive discovery data and signal data. The discovery data including, for example, CDP data, may indicate an association of the switches 112-122 and the access points 124A-134 connected to the corresponding switches 112-122. In various embodiments, the discovery data may be received from the switches 112-122 to which the access points 124A-134, deployed across the floors 104-108 in the multistory building 102, are connected. In still various embodiments, the discovery data may be received at the access points 124A-134 from their directed connected switches 112-122 or from other network entities and forwarded to the controller 110. The discovery data may include, for example, at least one of a device name or a location identifier of each of the access points 124A-134 connected to the corresponding switches 112-122. In further examples, the discovery data may include at least one of a device name or a location identifier of each of the switches 112-122. In one or more embodiments, the discovery data including, for example, a device name of each of the switches 112-122 may be received by the access points 124A-134 and forwarded to the controller 110. In several embodiments, the device name may refer to a name provided by an administrator of the network device, for example, the access point or the switch. The location identifier may refer to any location-identifying numbering or string (e.g., “wiring closet X.Y”). In various embodiments, the access points 124A-134 may receive the discovery data from their directly-connected switches 112-122 or other network entities. In yet various embodiments, the access points 124A-134 may transmit the received discovery data to the controller 110. The signal data including, for example, Received Signal Strength Indicator (RSSI) data, may be associated with the access points 124A-134. The controller 110 may receive the discovery data from the switches 112-122 and/or the access points 124A-134, and the signal data from the access points 124A-134. The controller 110 may classify the access points 124A-134 into a set of clusters based on the received discovery data and the received signal data. In still further embodiments, the controller 110 may perform unsupervised machine learning to classify the access points 124A-134 into the set of clusters. In still additional embodiments, a cluster of the set of clusters may correspond to one of the floors 104-108. In some more embodiments, the controller 110 may determine a number of floors in the space based on a count of clusters in the set of clusters. For example, the controller 110 may determine three floors 104, 106, and 108 based on three clusters obtained by classifying the access points 124A-134.

The controller 110 may then determine a sequence of the floors 104-108 based on the set of clusters. In yet various embodiments, prior to determining the sequence of the floors 104-108, the controller 110 may validate the set of clusters. In yet more embodiments, the controller 110 may validate the set of clusters based on a variance value between the set of clusters and a variance value within the set of clusters. Further, the controller 110 may allocate a floor-level ID to at least one access point (e.g., any one of the access points 124A-134) based on the determined sequence. For example, the controller 110 may allocate the floor-level ID, Floor 1, to the access points 124A-124C that are connected to the switch 112 and the access points 126A and 126B that are connected to the switch 114. Similarly, in another example, the controller 110 may allocate the floor-level ID, Floor 2, to the access points 128A-128E that are connected to the switch 116. Similarly, in another example, the controller 110 may allocate the floor-level ID, Floor 3, to the access points 130A and 130B that are connected to the switch 118, the access points 132A and 132B that are connected to the switch 120, and the access point 134 that is connected to the switch 122. In still yet more embodiments, the controller 110 may transmit an indication of the floor-level IDs allocated to the access points 124A-134. In one or more embodiments, floor-level information including the floor-level IDs allocated to the access points 124A-134 may be stored at the controller 110 and provided to each of the access points 124A-134 for various purposes, for example, for determining neighbor reports, roaming recommendations, or the like. In several more embodiments, the floor-level information including the floor-level IDs allocated to the access points 124A-134 may be provided to a location engine, for example, for locating client devices, rogue access points, or the like. The location engine may be deployed, for example, at a location server, a mobility services engine, a cloud-based platform configured for location-based services, or the like. In still more embodiments, the mapping of an access point to its floor-level identifier may be transmitted to other access points and network entities that rely on the floor-level identifier for performing various operations such as localization, reporting, roaming recommendations, or the like. In further embodiments, each access point (e.g., any of the access points 124A-134) may transmit measurement data to a location engine for localization of client devices.

In many further embodiments, each access point (e.g., any of the access points 124A-134) may execute an allocation logic that is configured to transmit signal data, for example, the RSSI data, receive the floor-level ID allocation based on the transmitted signal data and the discovery data received from the switches 112-122, and localize one or more client devices based on the received floor-level ID allocation. The discovery data may be associated with the access points 124A-134 that are deployed across the floors 104-108 in the multistory building 102.

In many additional embodiments, the present disclosure may utilize real-time reported RSSI data and CDP data from all the access points 124A-134 within the multistory building 102 to estimate the number of floors 104-108 and a corresponding floor-level ID allocated to each access point (e.g., any of the access points 124A-134), thereby eliminating the need for air pressure sensors in or external to the access points 124A-134 for floor identification and floor-level localization. In still yet further embodiments, the devices and methods discussed herein may utilize the RSSI data and the CDP data for advanced data analysis, calculation of inner weights and inter weights of the set of clusters, neighboring floor identification, unsupervised machine learning utilized for cluster combination, floor classification based on a graph constructed from the inner weights and the inter weights of the set of clusters, and supporting real-time updates, thereby enhancing the efficiency, accuracy, and adaptability of the system 100 compared to conventional data analysis and classification systems. In still yet additional embodiments, the devices and methods discussed herein may not require user inputs such as the number of floors or a floor search interval for performing floor-level allocation of the access points 124A-134 and indoor localization.

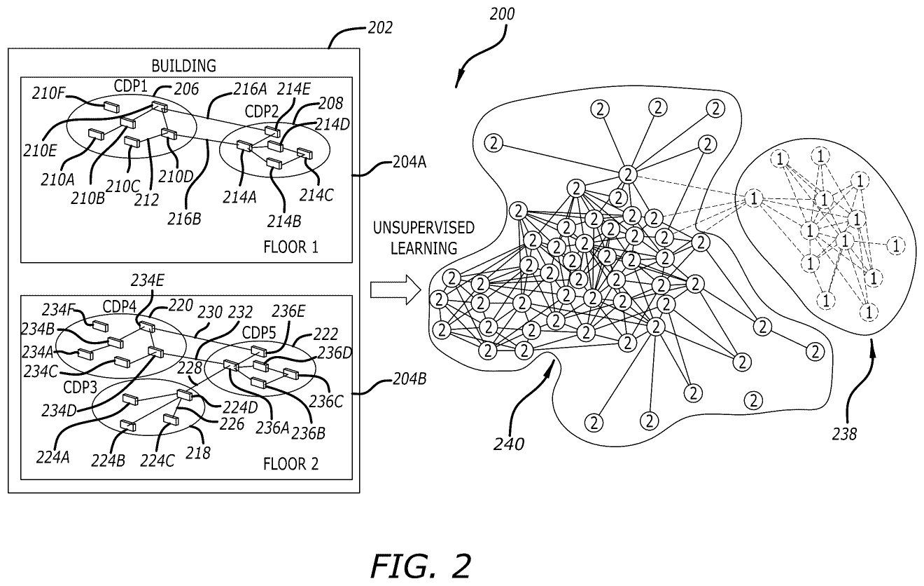

Although a specific embodiment for a system 100 implemented in an indoor space including multiple floors with access points connected to corresponding switches suitable for carrying out the various steps, processes, methods, and operations described herein is discussed with respect to FIG. 1, any of a variety of systems and/or processes may be utilized in accordance with embodiments of the disclosure. For example, discovery of the access points 124A-134 that are connected to corresponding switches 112-122 deployed across the floors 104-108 in the multistory building 102 can be offloaded to the controller 110. The controller 110 may implement the CDP for discovering neighboring devices such as the access points 124A-134 connected to the switches 112-122 and gathering information therefrom for utilization in classification of the access points 124A-134 into a set of clusters. The elements depicted in FIG. 1 may also be interchangeable with other elements of FIGS. 2-11 as required to realize a particularly desired embodiment.

Referring to FIG. 2, a schematic diagram 200 illustrating an unsupervised machine learning method for floor-level allocation of network devices in accordance with various embodiments of the disclosure is shown. In many embodiments, the present disclosure may implement a method for identifying neighboring floors within an indoor space, for example, a building 202 with multiple access points, in a sequence, without the need for air pressure data. In a number of embodiments, the devices and methods discussed herein may perform this floor identification through an integration of RSSI data from the access points and CDP data of the switches and the access points received from the switches and/or the access points deployed across one or more floors in the building 202, and by classifying floors based on connectivity weights between the access points of each pair of adjacent switches. In a variety of embodiments, the devices and methods discussed herein may correctly group even isolated access points (that is, those access points not appearing on a connectivity RSSI list) into an appropriate floor.

In various embodiments, the devices and methods discussed herein may leverage unsupervised machine learning for classifying the access points into a set of clusters and achieving accurate results without prior knowledge of the number of floors in the building 202. A cluster may refer to a group of data points that are similar to each other based on their relation to surrounding data points. In more embodiments, the controller may process each switch and the access points connected to the switch as a separate cluster initially, and then combine the clusters based on their connectivity weight. In additional embodiments, by implementing the CDP, the controller may correctly group even an access point that is isolated, that is, does not appear on an RSSI list, into an appropriate cluster. As illustrated in FIG. 2, each switch may keep isolated access points on the right floor by maintaining the access points in the same cluster. Additionally, as neighboring floors are typically connected, and if a few access points from two clusters on two neighboring floors show strong RSSI, the controller may ensure these two clusters are not combined due to the high density of connections within each cluster. Conversely, if two clusters on the same floor have a high connectivity weight, the controller intelligently combines them. This combination leverages advanced machine learning classification algorithms and robust quality validation.

By way of a non-limiting example, in further embodiments, the devices and methods discussed herein may employ an unsupervised machine learning algorithm such as the Leiden algorithm for classifying the access points into a set of clusters. The Leiden algorithm may refer to an advanced community detection algorithm for clustering that may enhance the precision of floor identification. The Leiden algorithm may identify clusters with high accuracy, ensuring reliable floor-level differentiation. The Leiden algorithm may exhibit an enhancement over the Louvain method, characterized by incorporating a refinement phase which may enhance the quality of partitioning and increase a capacity for identifying clusters with high precision. The Leiden algorithm may cluster data values such that a Mean Square Error (MSE) of all data values within a given cluster may be minimized. Through the iterative reassignment of data points to different clusters to optimize overall modularity, the Leiden algorithm may enhance the precision of the floor identification. Modularity may measure the density of connections within the clusters compared to connections between the clusters. As floor identification may be an unsupervised machine learning process, and since the number of floors may not be known prior to clustering, in still more embodiments, the devices and methods discussed herein may utilize an index, for example, the Calinski-Harabasz Index (CHI), to validate the quality of clusters. The Leiden algorithm and the CHI may, therefore, together improve accuracy of indoor spatial localization. For purposes of illustration, the present disclosure refers to employing the Leiden algorithm for clustering and the CHI for validating the clusters created by the Leiden algorithm; however, the scope of the devices and method discussed herein may not be limited to the Leiden algorithm and the CHI, but may extend to employ any other unsupervised machine learning algorithm for clustering and any other index for validating the clusters.

Consider an example of floor-level allocation of multiple access points deployed across two floors 204A and 204B of a building 202. In this example, on Floor 1 204A of the building 202, 6 access points 210A-210F may be directly connected to a first switch and 5 access points 214A-214E may be directly connected to a second switch. Further, on Floor 2 204B of the building 202, 4 access points 224A-224D may be directly connected to a third switch, 6 access points 234A-234F may be directly connected to a fourth switch, and 5 access points 236A-236E may be directly connected to a fifth switch. In still further embodiments, the controller may integrate RSSI data and discovery data such as CDP data as inputs to a classifier. The controller may process each switch and the access points connected to the switch as a separate cluster initially, and then combine the clusters based on their connectivity weight. The controller may determine whether the switches are on the same floor or separated between the floors. In the example scenario shown in FIG. 2, each cluster representing a switch may be referenced as CDP1 206, CDP2 208, CDP3 218, CDP4 220, and CDP5 222. For the example scenario shown in FIG. 2, the controller may execute floor-level allocation of the access points 210A-236E as follows:

In Step 1, the controller may receive the RSSI data from the access points and the CDP data from the access points or from the switch to which the access points are connected. The controller may map the access points to the initial clusters CDP1 206, CDP2 208, CDP3 218, CDP4 220, and CDP5 222 by utilizing the received CDP data. RSSI may refer to a measure of the signal strength that an access point detects from neighboring access points. Each access point may monitor the signal strength of its nearby access points to facilitate management of network performance. The RSSI may be measured in decibels relative to 1 milliwatt (dBm) and may reflect how strong the signal is when the signal reaches an access point. In still additional embodiments, the controller may aim to detect the number of communities, herein referred to as “floors”, in the building 202 by grouping the switches based on similarity of the RSSI data reported by their access points. In this context, a floor can be viewed as a community of switches with connected access points reporting strong RSSI values from each other.

In Step 2, the controller may apply the Leiden Algorithm, which seeks to maximize modularity (Q). Modularity (Q) may measure the strength of division of a network into communities or clusters. Consider the following network representation of the building 202, where each node in the network may be a cluster referenced as a “CDP”, and an edge between two nodes may indicate that the CDPs have some commonality in the RSSIs reported by connected access points. The weight of the edge may represent how strong the RSSI values are. Higher weights may indicate a high RSSI reported by the access points of the two CDPs. For example, if the access points 210A-210F in CDP1 206 report very high RSSIs from the access points 214A-214E in CDP2 208, the controller may conclude that CDP1 206 and CDP2 208 can be on the same floor. Thus, the edge 216A or 216B connecting CDP1 and CDP2 may have a higher weight. In the example scenario shown in FIG. 2, there are five switches represented as clusters and denoted as CDP1 206, CDP2 208, CDP3 218, CDP4 220, and CDP5 222 overseeing different access points, with various RSSI reportings. The connection between two access points in each cluster may be represented by an edge. For example, one connection between two access points 210C and 210D in CDP1 may be represented by an edge 212. Similarly, one connection between two access points 224A and 224B in CDP3 may be represented by an edge 226. The connection between the two clusters CDP3 218 and CDP5 222 may be represented by an edge 228, while the connections between clusters CDP4 220 and CDP5 222 may be represented by edges 230 and 232.

Prior to proceeding with clustering, in some more embodiments, the controller may apply an unsupervised outlier detection technique using the Isolation Forest algorithm to the CDP data associated with each switch. This step may identify the access points that have no RSSI reportings, ensuring that isolated access points can still be appropriately grouped into their respective clusters based on connectivity weight such as CDP data weight.

In Step 3, the controller may then proceed to execute clustering. The controller may start with “Initialization”. In the initial step, each CDP may start as its own cluster. That is, CDP1 206, CDP2 208, CDP3 218, CDP4 220, and CDP5 222 may represent separate clusters. “Initialization” may be followed by connectivity weight calculation. During connectivity weight calculation, inner weights for each cluster and inter weights between different clusters are determined. The inner weights may represent the strength of connections among the access points connected to the same CDP. The inter weights between different clusters may be determined based on RSSIs reported by the access points connected to a CDP with access points connected to another CDP. This connectivity matrix may facilitate the identification of linked clusters. After connectivity weight calculation, the controller may proceed to graph construction. Using the determined inner weights and inter weights, the controller may generate a graph where each node may represent a CDP, and each edge may reflect the connectivity weight between the CDPs, indicating how similarly their access points are connected based on the RSSI values. Once the graph is generated, the controller may then apply the unsupervised learning, for example, by using the Leiden algorithm. The Leiden algorithm may include various learning phases, for example, Local Move Phase, Refinement Phase, Aggregation Phase, and Iteration.

In the Local Move Phase, for each CDP “i”, the controller may calculate the change in modularity (ΔQ) for moving the CDP to the community of a neighboring CDP based on the RSSIs reported by the connected access points. For example, when moving CDP1 206 to the community of CDP2 208, the controller may check whether the access points 210A-210F report high RSSI values for the access points 214A-214E. If a CDP is connected to another CDP by an edge with a high weight, the controller may check whether moving the CDP to the neighbor's community improves modularity. For example, the controller may compare CDP1 206 with CDP2 208. In this example, the access points 210A-210F and 214A-214E of CDP1 206 and CDP2 208, respectively, may report high RSSI values with each other, and hence an edge with a high inter weight may exist between them. If CDP1 206 and CDP2 208 merge into one cluster, the controller may calculate the gain in modularity ΔQ. If moving CDP1 206 to CDP2's 208 community increases modularity, the controller may merge the two clusters. If not, the controller may not merge the two clusters. Similarly, the controller may compare CDP1 206 with other CDPs such as CDP3 218, CDP4 220, and CDP5 222. The controller may move CDP1 206 to the community for which ΔQ is maximized (but only if ΔQ>0). The controller may repeat the Local Move Phase for all CDPs, that is, CDP1 206, CDP2 208, CDP3 218, CDP4 220, and CDP5 222, until no further moves that increase modularity are possible.

In the Refinement Phase, the controller may refine the clusters. In this phase, instead of moving individual CDPs, the entire cluster with one or more CDPs is considered for moving to a new cluster if the move increases modularity. For example, if CDP1 206 and CDP2 208 form a merged cluster in the local move phase, the entire cluster of CDP1 206 and CDP2 208 can be considered for moving into another community, for example, the community of CDP3, if the move increases modularity.

After refining the partitions, the controller proceeds to the Aggregation Phase. In the Aggregation Phase, the controller may aggregate communities and construct a new network where each partition (e.g., group of one or more CDPs and their access points) may represent a community. For example, after merging, the partitions may include two communities such as Community 1 and Community 2. Community 1 may include CDP1 206 and CDP2 208 and their access points, while Community 2 may include CDP3 218, CDP4 220, and CDP5 222 and their access points. Thus, a new aggregated network is created where edges between partitions or communities represent the sum of the edges between their corresponding communities

The Aggregation Phase is followed by the Iteration phase in which the controller may repeat the Local Move Phase and the Refinement Phase on this new aggregated network until no further improvement in modularity can be made. After the iterations, the controller may output a set of clusters, that is, communities of CDPs, which represent the unique floors 204A and 204B within the building 202.

In Step 4, the controller may evaluate clustering with an index, for example, the CHI. Once the set of clusters that correspond to the floors 204A and 204B of the building 202 is obtained, the next step is to evaluate the quality of these clusters using the CHI. CHI may measure, for example, a between-group dispersion matrix (B) and a within-group dispersion matrix (W). The between-group dispersion matrix (B) may indicate how much the detected clusters differ from each other. Higher “B” values may indicate that clusters are well-separated. Further, the within-group dispersion matrix (W) may indicate how similar the CDPs within each cluster are. Lower “W” values may indicate that clusters within the same cluster have same RSSI profiles from the access points and can be on same floor. The CHI may be determined based on the equation (1) as shown below:

$$CHI = \frac{[ \frac{B}{K - 1} ]}{[ \frac{W}{N - K} ]} \qquad ( 1 )$$

where,
K is the number of clusters (floors in this case); and
N is the total number of CDPs.

In the above example scenario, consider that the controller obtains the following two clusters: Community 1: CDP1 206 and CDP2 208 and their APs (Floor 1 204A); and Community 2: CDP3 218, CDP4 220, and CDP5 222 and their APs (Floor 2 204B). Using task similarity metrics, the controller may determine “B”, that is, how different the two clusters are, and W, that is, how similar the CDPs within each cluster are. A high value of the CHI may indicate that the clusters are well-separated and well-defined. A low value of the CHI may indicate that the clusters may not be well-formed, indicating an overlap between the clusters.

In Step 5, the results are interpreted. For example, the result of the Leiden algorithm may provide a partitioning of the CDPs and their access points in the building 202 into distinct clusters where each cluster may correspond to a unique floor based on RSSI reporting. The CHI may help in assessing whether these partitions are meaningful and well-defined. For example, a high CHI value may indicate that the clustering of CDP1 206 and CDP2 208 into one floor 204A, and CDP3 218, CDP4 220, and CDP5 222 into another floor 204B, represent a clear floor structure, where CDPs on different floors are allocated into different clusters. The final number of floors may be determined by the following equation (2):

$$Number of Floors = arg max \{ CHI\_n \} for : 1 <= n <= max number of CDPs \qquad ( 2 )$$

In Step 6, the controller may estimate the sequence or order of the floors. Inter edge weights between final clusters can indicate whether a cluster is linked to another cluster. Decreasing weights would indicate an increasing distance between clusters and in turn difference in floor levels. By verifying the edge weights, a vertical sequencing or ordering of floors can be obtained and a floor-level ID can be assigned to each floor as per the order. Further, all CDPs and access points in a cluster mapped to a floor can be allocated the floor-level ID as per the sequencing.

In Step 7, each access point may be assigned a floor-level ID, facilitating the creation of a vertical order in the floor levels. As shown in FIG. 2, the controller may allocate the floor-level ID, Floor 1 204A of the building 202 to the 6 access points 210A-210F in the CPD1 206 and the 5 access points 214A-214E in the CPD2 208. Similarly, the controller may allocate the floor-level ID, Floor 2 204B of the building 202 to the 4 access points 224A-224D of the CPD3 218, the 6 access points 234A-234F of the CPD 220, and the 5 access points 236A-236E of the CPD5 222, as shown in FIG. 2. After unsupervised learning, the access points 210A-210F and 214A-214E and the access points 224A-224D, 234A-234F, and 236A-236E represented by two clusters 238 and 240 are allocated to two adjacent floors 204A and 204B, respectively, as illustrated in FIG. 2. Despite having a few connections between the access points, the internal density connectivity weight classified the access points into separate floors 204A and 204B.

Although a specific embodiment for an unsupervised machine learning method for floor-level allocation of network devices suitable for carrying out the various steps, processes, methods, and operations described herein is discussed with respect to FIG. 2, any of a variety of systems and/or processes may be utilized in accordance with embodiments of the disclosure. For example, in yet various embodiments, the devices and methods discussed herein may perform clustering by employing any of a plurality of alternative unsupervised machine learning algorithms selected, for example, from a Louvain algorithm, a random walk graph partitioning algorithm, a spectral clustering algorithm, a label propagation algorithm, an affinity propagation algorithm, or the like. The elements depicted in FIG. 2 may also be interchangeable with other elements of FIG. 1 and FIGS. 3-11 as required to realize a particularly desired embodiment.

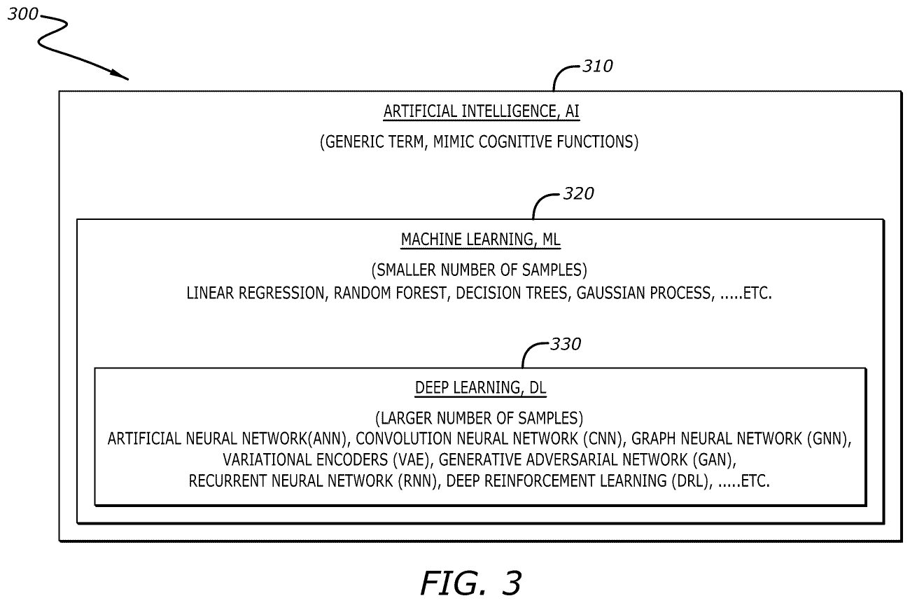

Referring to FIG. 3, a schematic diagram 300 illustrating various subsets of artificial intelligence in accordance with various embodiments of the disclosure is shown. Artificial intelligence (AI) 310 is typically understood in the art to be the development of machines and algorithms that mimic human intelligence, for example, by optimizing actions to achieve certain goals. At its core, AI 310 often involves designing algorithms and models that mimic cognitive functions, such as learning, reasoning, problem-solving, perception, and even language understanding. Unlike traditional computer programs that follow a fixed set of instructions, AI systems can adapt, improve, and make decisions based on input data and environmental interactions.

AI 310 can be considered a generic term because AI 310 encompasses a wide range of subfields and techniques, from simple rule-based systems to advanced machine learning and deep learning models. These AI techniques are used to simulate various aspects of human cognition. For example, machine learning (ML) 320 allows computers to learn from data patterns without explicit programming for each task, while Natural Language Processing (NLP) enables machines to understand and generate human language. Deep learning (DL) 330, a more advanced branch of AI, utilizes neural networks to automatically learn complex patterns from large datasets, akin to information processing by the human brain. This versatility makes AI 310 a powerful tool across diverse applications, including floor identification, image recognition, autonomous driving, voice assistants, healthcare diagnostics, and materials discovery.

A goal of AI 310 is often to create systems that can function autonomously and intelligently in real-world scenarios. As AI 310 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML) 320 is a subset of AI 310 that focuses on the development of algorithms and statistical models that enable computers to learn and make decisions from data without explicit programming. In traditional programming, a computer is given a fixed set of rules to follow, but ML 320 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized to classify a plurality of access points into a set of clusters based on discovery data such as CDP data, and signal data such as RSSI data.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques such as linear regression, decision trees, random forests, and Gaussian processes are commonly used in ML 320. These algorithms can handle various data types, including numerical, categorical, and structured datasets such as spreadsheets or grids. One of the strengths of ML 320 is its ability to generalize from the training data to make accurate predictions on new, unseen data. In a number of embodiments described herein, training data may be generated from CDP data, RSSI data, developer inputs, quality assurance/testing feedback, among other sources.

However, traditional ML methods rely heavily on feature engineering, wherein human experts manually identify the most relevant features or patterns within the data. For example, when using ML 320 for image recognition, an expert may need to extract features such as edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than 100) to learn effectively.

Deep Learning (DL) 330 is a specialized subset of Machine Learning (ML) 320 that employs multi-layered artificial neural networks to automatically learn complex patterns and representations from large, often unstructured datasets. Inspired by the way the human brain processes information, DL 330 includes interconnected layers of “neurons” that can adaptively change as they are exposed to more data. Unlike traditional ML methods, which require manual feature engineering to identify data characteristics, DL models can automatically extract features directly from raw data, such as images, text, or molecular structures. This automated feature extraction allows DL 330 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, access points, or atomic interactions. They can learn the dependencies and relationships within graph-like structures, which is crucial for predicting properties of complex molecules and materials. For example, the access points that are connected to corresponding switches and their relationships are modeled as a graph, which may be input into a GNN with RSSI data and CDP data for predicting the floors of a multistory building where they are disposed. By organizing the access points into a graph structure, situations where the exact positions of the access points in a multistory building are unknown, may be handled optimally. RNNs and their variants, such as Long Short-Term Memory (LSTM) networks, are suited for sequential data such as time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques such as Variational Autoencoders (VAEs) and Generative Adversarial Networks (GANs) add to the versatility of DL 330 by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding the application potential of DL 330. In summary, the ability of DL 330 to automatically learn from raw, unstructured data and model intricate patterns makes it a powerful tool in AI, particularly for complex domains such as image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is utilized to measure the difference between the prediction and the actual result. The network's weights can be adjusted through a process called gradient descent, which can be configured to minimize the loss function over time. However, the training process can be prone to problems such as overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of ML neural network designed to work particularly well with image data, making them highly relevant for generating image data for transmission over networks, which may be subject to processing. As those skilled in the art will recognize, CNNs typically utilize specialized layers known as convolutional layers, which apply filters (also known as kernels) to the input data. These filters slide over the input (e.g., an image), detecting patterns such as edges or textures, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction, such as classifying a plurality of access points into a set of clusters, generating a score suitable for evaluation of the clusters, or facilitating multi-floor classification.

While CNNs are well-suited for grid-based data like images, many real-world problems can involve non-grid data, such as access point locations, network device interactions, or the like. This type of data may better be represented as a graph, where nodes represent entities (e.g., access points) and edges represent relationships between them (e.g., connections between the access points). Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is crucial in predicting properties that depend on the current/local structure, such as the behavior of an access point or the properties of a network.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space. This can be utilized when attempting to construct a graph based on inner weights of a cluster or inter weights between clusters or the like.

Similarly, GANs include two components: a generator that creates fake/generated data and a discriminator that tries to distinguish between real and fake data. The two components are trained in a competitive process where the generator tries to “fool” the discriminator, leading to increasingly realistic generated data. This type of process may be utilized to produce synthetic samples that resemble the training data, which can help augment the dataset.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex signal simulations.

In floor-level allocation and indoor localization, DRL can be used in scenarios where an optimal decision needs to be made, such as optimizing floor identification or finding the best clusters based on the desired or current properties. The combination of RL and DL can allow for learning from raw data, making it a powerful tool for dynamic and real-time decision-making for floor-level allocation and indoor localization.

Although a specific embodiment for various subsets of artificial intelligence suitable for carrying out the various steps, processes, methods, and operations described herein is discussed with respect to FIG. 3, any of a variety of systems and/or processes may be utilized in accordance with embodiments of the disclosure. For example, another subset may be present and available for use within AI 310. Those skilled in the art will recognize that the diagram 300 presented in FIG. 3 is simplified for illustration purposes and various methods and techniques may interact with other areas (ML 320 with DL 330, etc.). The elements depicted in FIG. 3 may also be interchangeable with other elements of FIGS. 1-2 and FIGS. 4-11 as required to realize a particularly desired embodiment.

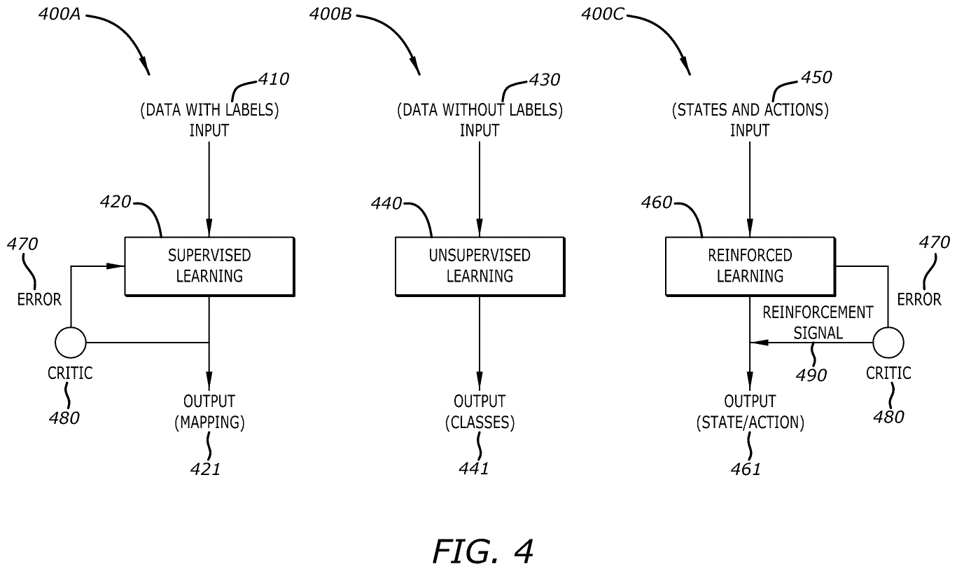

Referring to FIG. 4, a block diagram illustrating different methods of machine-based learning in accordance with various embodiments of the disclosure is shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data, and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 4, a supervised learning system 400A is shown. The supervised learning system 400A can be configured with a supervised learning model 420 that accepts input data 410 and generates an output 421. However, the output data is often reviewed by a critic 480 that can determine one or more errors 470 that are fed back into the supervised learning model 420 for use in updating.

Supervised learning systems 400A are often considered the simplest machine learning model to understand in which input data (such as training data) has a known label or result as an output. The supervised learning model 420 can, therefore, be understood to work on the principle of input-output pairs. As such, a function can be trained using a training data set, which is then applied to unknown data to make some predictions. Supervised learning is task-based and mostly tested on labeled data sets.

Supervised learning systems 400A may often involve one or more regression problems. In regression problems, the output is a continuous variable. Some commonly used regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be utilized for both regression and classification problems. A decision tree utilizes a tree-like structure of decisions along with their possible consequences and outcomes. In this, each internal node is utilized to represent a test on an attribute while each branch is used to represent the outcome of the test. The more nodes a decision tree has, the more accurate the result will be. This may be utilized when making decisions related to clusters and their separation. The advantage of decision trees is that they are intuitive and easy to implement, but may lack accuracy depending on the available computational or time resources available.

Random forests are an ensemble learning method, which may include a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are the other type of supervised learning, which can be used to generate conclusions from observed values in one or more categorical forms. For example, a classification model can identify if an email is spam or not; whether an access point is located on an appropriate floor, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste, yellow, oval, and sweet will be recognized as mango. Here each feature is independent of other features. Likewise, various embodiments herein can classify based on RSSI data, CDP data, etc.

Again, in the embodiment depicted in FIG. 4, an unsupervised learning system 400B is shown. The unsupervised learning system 400B can be configured with an unsupervised learning model 440 that accepts input data 430 and generates an output 441. Unlike other model types, there are no critics or error signals to process. Unsupervised learning models 440 can implement the learning process opposite to supervised learning, which means it enables the model to learn from an unlabeled training dataset. Based on the unlabeled dataset, the unsupervised learning model 440 can predict the output. Using an unsupervised learning system 400B, the unsupervised learning model 440 can learn hidden patterns from the dataset by itself without any supervision. In various embodiments, unsupervised learning models 440 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means clustering, hierarchal clustering, Density-based Spatial Clustering of Applications with Noise (DBSCAN), etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in yet various embodiments, an association rule system may be utilized to group devices into clusters and categorize them. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and Frequent Pattern (FP)-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, Principal Component Analysis (PCA), Singular Value Decomposition (SVD), etc.

In further embodiments, the present disclosure has been developed for floor classification in indoor localization, particularly in environments where environmental data such as air pressure data is incomplete, unreliable, or missing. The controller may integrate RSSI data and CDP data as components for inputs of a classifier. The controller may process each switch and the access points connected to the switch as a separate cluster initially, and then combines the clusters based on their connectivity weight. In this case, the CDP may allow even an access point that is isolated, that is, does not appear on an RSSI list, to be correctly grouped into the appropriate cluster. In still more embodiments, the present disclosure may include calculation of the inner weight of each cluster and keeping all access points connected to each switch with the same floor-level ID. This calculation may be utilized to gain deeper insights into the data and refine the precision of the system. Moreover, the inter weight calculation may allow the system to determine the connectivity weight between different floors, enabling the identification of neighboring floors in a sequence, which may be beneficial in cases where vertical positioning data is absent.

By having a connectivity matrix, a list of access points, and their CDP ID, the system may generate a graph using the computed inner weights within clusters and inter weights between clusters. In still further embodiments, the system may employ an advanced community detection algorithm, for example, the Leiden algorithm, which may exhibit an enhancement over the Louvain method, characterized by a refinement phase which increases capacity for identifying clusters with high precision. The Leiden algorithm may cluster data values such that the MSE of all data values within a given cluster is minimized. Through the iterative reassignment of data points to different clusters to optimize overall modularity, the Leiden algorithm may enhance the precision of the floor identification. Therefore, the Leiden algorithm may contribute significantly to the overall efficiency and accuracy of indoor spatial localization.

In still additional embodiments, a variance ratio criterion, for example, the CHI, may be a validation metric utilized for assessing the quality of a clustering model. The CHI may calculate the ratio of the sum of between-cluster dispersion to the sum of within-cluster dispersion. The between-cluster dispersion may measure how much the clusters differ from each other, and the within-cluster dispersion may measure how much the data points (in this case, the switches) within a single cluster differ. When the data points within the same cluster are similar (low within-cluster dispersion) and the clusters themselves are distinct and well separated (high between-cluster dispersion), the CHI value may be high, indicating a good clustering model. The CHI is particularly useful because it does not require any a priori knowledge of the ground truth labels of the clusters. This makes the CHI an effective metric for evaluating the performance of unsupervised machine learning models utilized herein.

In some more embodiments, the primary stages of the process discussed herein may include:
1) Outlier detection: Before the main process, an unsupervised outlier detection technique using an isolation forest per cluster associated with a switch and its connected access points is applied. The anomaly score of each sample is computed, measuring the local deviation of the density of a given sample with respect to its neighbors' data to remove weak RSSI weights.
2) Floor search interval: The search interval of the number of clusters may be defined as [1, maximum number of CDPs].
3) Application of the Leiden algorithm: The Leiden algorithm starts by initializing each CDP as an individual floor.
4) Validation step via the CHI: The CHI can be utilized as a validation metric for assessing the quality of a clustering model. The CHI calculates the ratio of the sum of between-cluster dispersion to the sum of within-cluster dispersion.
5) The final number of estimated floors would be:

$$Number of Floors = arg max \{ CHI\_n \} for : 1 <= n <= max number of CDPs$$

Further, in the embodiment depicted in FIG. 4, a reinforcement learning system 400C is shown. The reinforcement learning system 400C can be configured with a reinforcement learning model 460 that accepts input data 450 and generates an output 461. In reinforcement learning, the reinforcement learning model 460 learns actions for a given set of states that lead to a goal state. In the embodiment depicted in FIG. 4, a critic 480 can receive or otherwise notice an error 470 within the reinforcement learning model 460 actions, and transmit a reinforcement signal 490 to adjust the outcome/output such that the “reward” or “punishment” is adjusted to better model the future behaviors or processing of the reinforcement learning model 460.

The reinforcement learning model 460 is a feedback-based learning model that can take feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, State-Action-Reward-State-Action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 4, any of a variety of systems and/or processes may be utilized in accordance with various embodiments of the disclosure. For example, those skilled in the art will recognize that methods of learning described herein are generalized and may incorporate other types developed as well as a combination of one or more methods based on the goals of the desired application. The elements depicted in FIG. 4 may also be interchangeable with other elements of FIGS. 1-3 and FIGS. 5-11 as required to realize a particularly desired embodiment.

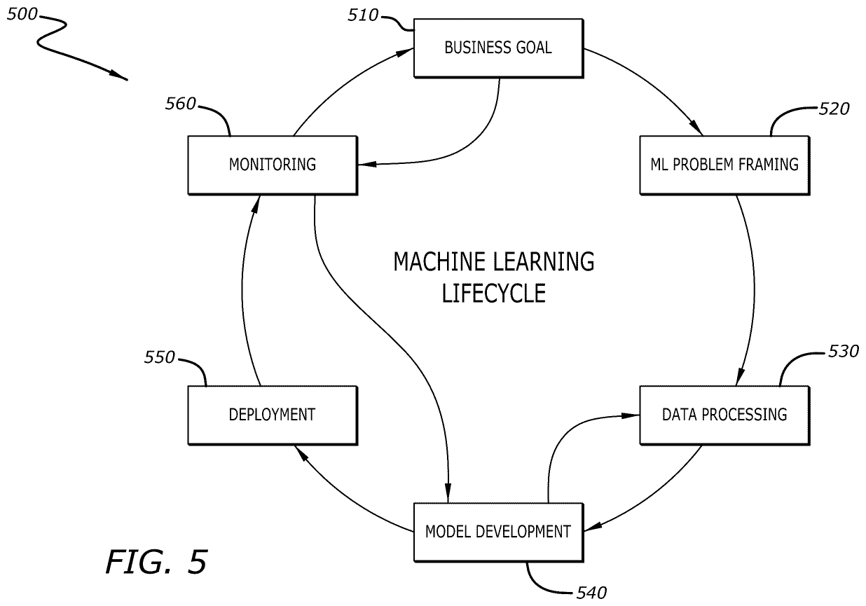

Referring to FIG. 5, a block diagram illustrating a machine learning lifecycle in accordance with various embodiments of the disclosure is shown. During the development of machine learning systems, the embodiment depicted in FIG. 5 can provide a framework for how to structure the design and maintenance of these systems. This machine learning lifecycle 500 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 500 emphasizes that developing a machine learning model is not a one-time effort but an iterative process requiring ongoing monitoring and adjustment. The feedback loop inherent in the machine learning lifecycle 500 allows for continual refinement and optimization of models to maintain their accuracy and relevance.

In many embodiments, a first stage of the machine learning lifecycle 500 is identifying the business goal 510, which sets the overall direction and purpose of the ML project. This can involve understanding the specific problems or opportunities within the business or project that machine learning can address. A clear business goal 510 ensures that the project remains focused on delivering tangible value, whether it is improving floor-level allocation of access points or optimizing the process of indoor localization. Without a well-defined goal, it can be challenging to align the subsequent stages of the ML lifecycle 500, as the choice of model, data processing methods, and performance metrics can all depend on what the business aims to achieve.

Establishing a proper business goal 510 can also involve engaging with key stakeholders and developers to gather requirements and set success criteria. It can provide a roadmap that outlines what success looks like and helps in framing the ML problem. For example, if the goal is to reduce computation load involved in indoor localization in a building with a massive number of access points, the project might focus on building a predictive model that utilizes RSSI data and CDP data for clustering and floor-level allocation of the access points. Clearly defined goals not only help guide the project but also provide benchmarks for evaluating the effectiveness of the deployed model once it enters production.

Once the business goal 510 is established, various embodiments take a next step involving ML problem framing 520, wherein the goal is translated into a specific machine learning task. This can involve selecting the appropriate type of ML problem, such as classification, regression, clustering, or recommendation, and defining the target variables or outputs. For example, if the goal is to identify floors in a multistory building, the problem can be framed as a classification task where the model determines a sequence of the floors based on a set of clusters and allocates a floor-level identifier to at least one access point based on the determined sequence. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 530 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 530 can require or at least benefit from careful planning and iterative refinement. Once the data is processed, it is typically split into training, validation, and test sets to develop and evaluate the model, ensuring that it generalizes well to new, unseen data.

Model development 540 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 540, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 530.

In further embodiments, deployment 550 is the stage where the developed model is integrated into the production environment to perform its intended tasks. This phase may involve setting up the necessary infrastructure, such as Application Programming Interfaces (APIs) or cloud-based services, to allow the model(s) to process live data and generate predictions. Deployment 550 can transform the model from a research tool into a functional component of a business process or product, providing real-time insights, automations, or decisions.

Proper deployment 550 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 510.

In more embodiments, monitoring 560 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 560, teams can identify when the model's performance drops and requires retraining or adjustments to align with the evolving data.

Monitoring 560 can also encompass aspects such as user feedback, security, and compliance, ensuring that the model remains effective, reliable, and ethical in its application. It may serve as the feedback loop in the lifecycle, where insights gained from monitoring feed back into the earlier stages, particularly data processing 530 and model development 540, to refine the model(s) as needed. This iterative process allows the machine learning system to adapt and maintain its alignment with the original business goal 510 over time.

Although a specific embodiment for a machine learning lifecycle suitable for carrying out the various steps, processes, methods, and operations described herein is discussed with respect to FIG. 5, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 5 may also be interchangeable with other elements of FIGS. 1-4 and FIGS. 6-11 as required to realize a particularly desired embodiment.

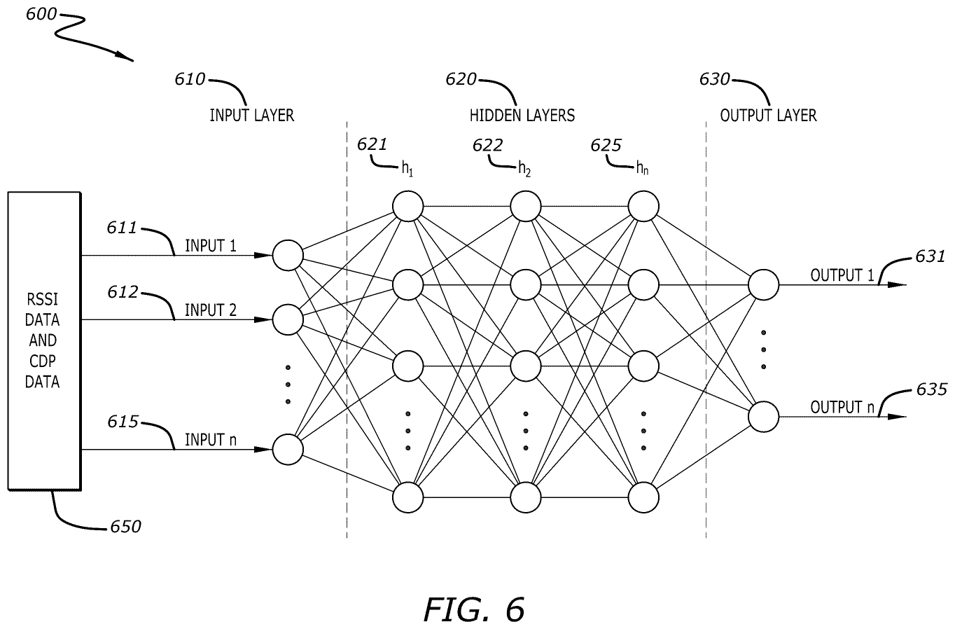

Referring to FIG. 6, a schematic diagram illustrating an exemplary neural network in accordance with various embodiments of the disclosure is shown. The embodiment depicted specifically depicts a feedforward neural network with multiple layers. This type of network includes an input layer 610, one or more hidden layers 620, and an output layer 630. Each layer contains nodes (or neurons) that are interconnected, representing how data flows through the network. The input layer 610 can receive raw data, which is then processed by the hidden layers 620 through weighted connections and activation functions. These hidden layers 620 can enable the network to learn complex patterns and relationships within the data.

The final output layer 630 produces the network's predictions or classifications based on the processed input. The interconnected nature of the nodes allows the neural network 600 to learn from data during training by adjusting the weights of connections to minimize prediction errors. This structure is the foundation of deep learning models, as adding more hidden layers 620 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 600 depicted in the embodiment of FIG. 6, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly utilized in both feedforward and other types of networks such as recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training such as RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize vertical ordering of floor levels in a building. It is also useful in regression problems, where input features can be processed to output continuous values. However, this is a general example of an AI model, illustrating how a feedforward neural network works. Depending on the problem, other methods and models may be more appropriate. For example, CNNs are often used for image processing tasks, while RNNs are suitable for sequential data like time series data or text. Additionally, simpler models like linear regression, decision trees, or SVMs may be sufficient if the problem is less complex, or the dataset is relatively small. The embodiment depicted in FIG. 6 is presented as an exemplary ML solution that may be deployed within one or more methods or systems described herein.

In many embodiments, the input layer 610 is the first layer in a neural network 600 and serves as the initial point where raw data is introduced into the model. Each node (or neuron) in this layer represents an individual feature or variable from the dataset, allowing the network to receive and process various types of data, such as RSSI data, CDP data, or the like. For instance, in floor-level classification tasks, the input layer can consist of nodes that correspond to the RSSI data of access points and CDP data received from switches, providing the network with the signal data and discovery data needed to classify floor-levels. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 600 are generally scaled i.e., normalized to have a zero mean and/or unit standard deviation. Scaling can also be applied to the input of hidden layers (using batch or layer normalization) to improve the stability of neural network 600.

Unlike the hidden layers 620 and output layers 630, the input layer 610 typically does not perform any computations or transformations on the data. Its primary function is often to pass the input data to the next layer in the network, the first hidden layer 621. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 610 itself does not modify the data, it sets the stage for the neural network to extract complex patterns and relationships through the deeper layers. This flexibility in handling various types of input make the neural network 600 a powerful tool for a diverse set of applications.

With respect to the embodiments described herein, the input layer may be configured with a plurality of inputs providing RSSI data and CDP data 650. For example, a model can be configured with a first input 611 configured as RSSI data and CDP data associated with one switch, a second input 612 is configured with RSSI data and CDP data associated with another switch, while additional inputs can be added related to the number of switches in the system. The nth input 615 can be configured in certain embodiments to include the current switch such that a determination to keep the current switch in place may be possible. However, as those skilled in the art will recognize, additional setups can be configured such that the inputs can be configured to also include different parameters of the network devices, the number of access points connected to each switch, the overall scores of previous analyses, among other input types, etc.

In a number of embodiments, the neural network 600 comprises a plurality of hidden layers 620. The embodiment depicted in FIG. 6 comprises a first hidden layer 621, a second hidden layer 622, and an nth hidden layer 625, which are denoted as h₁, h₂, and hₙ respectively. In many embodiments, the hidden layers 620 are disposed where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 621 h₁ receives direct input from the input layer, transforming the raw data into an initial set of features. For example, in an image recognition task, this layer might begin identifying basic patterns, such as edges or simple textures. The output of the first hidden layer 621 is then passed to a second hidden layer 622 h₂, which builds upon the features identified by the first hidden layer 621. This deeper layer might start recognizing more complex patterns, such as shapes or specific object components, by combining the lower-level features identified earlier. This can continue until a last, nth hidden layer 625 hₙ continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the first input layer 621 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 630 is often the final layer in a neural network and is responsible for producing the network's predictions or classifications based on the information processed through the previous hidden layers 620. Each neuron in the output layer 630 can represent a specific outcome or category that the model can predict. In the embodiment depicted in FIG. 6, the outputs are labeled as “output 1” 631 to “output n” 635, indicating that the network can be designed to have a varying number of outputs depending on the nature of the problem being solved for. For example, in a binary classification, there would typically be a single output neuron that provides a probability score for one of the two classes/outcomes. In contrast, for multi-class classification (e.g., categorizing best clusters for floor identification), the output layer would contain multiple neurons, each corresponding to a different class.

The number of neurons in the output layer 630 can also designed specifically for other types of tasks, such as regression, where the model can predict continuous values. In such cases, the output layer 630 might contain a single neuron representing a numerical prediction, such as the price of a house or the temperature forecast, etc. Alternatively, in complex applications like multi-label classification (where each input can belong to multiple classes simultaneously), the output layer 630 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a softmax function can be applied to output a set of probabilities that sum to 1, indicating the most likely class. For regression problems, a linear activation function is often used to output a continuous range of values. The flexibility in designing the output layer allows the neural network 600 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 6, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 6, which is an illustrative example meant to make it easier to explain the basic concepts of neural networks and how they process information. The specific features and functions described herein are not intended to be limiting to this specific embodiment. The elements depicted in FIG. 6 may also be interchangeable with other elements of FIGS. 1-5 and FIGS. 7-11 as required to realize a particularly desired embodiment.

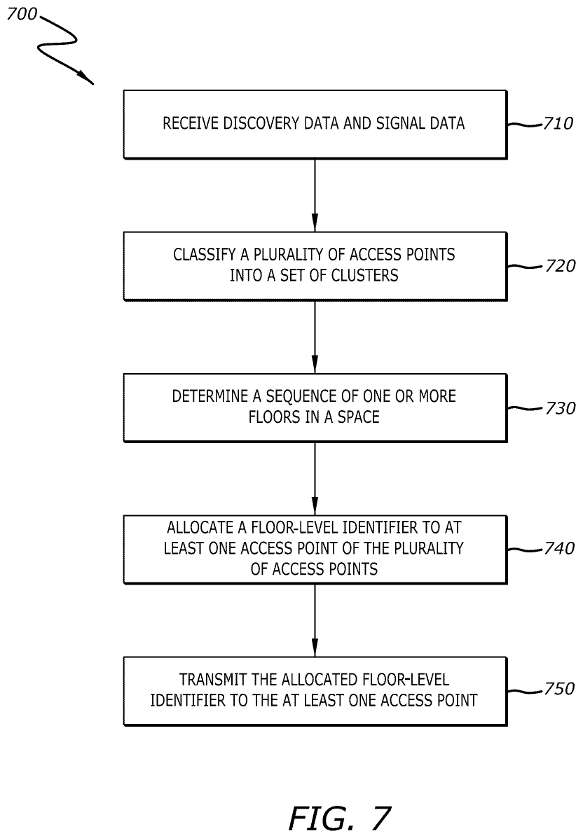

Referring to FIG. 7, a flowchart depicting a process 700 for floor-level allocation of network devices in accordance with various embodiments of the disclosure is shown. In many embodiments, the network devices may include access points deployed across one or more floors of a space, for example, an indoor space such as a building. One or more of the access points may be connected to a set of switches deployed across one or more floors of the space. In a number of embodiments, the access points may provide their own signal data, for example, RSSI data, and signal data associated with neighboring access points. In one or more embodiments, the access points may provide their discovery data. In further embodiments, the switches may provide discovery data associated with the access points.

In a variety of embodiments, the process 700 may receive discovery data and signal data (block 710). In several embodiments, the discovery data may be received from the switches to which the access points deployed across one or more floors in the space, are connected. In several other embodiments, the discovery data may be received from the access points directly connected to corresponding switches. In various embodiments, the switches may be configured to implement a CDP. The CDP may refer to a layer 2 management protocol for networks, that facilitates collection of information of the access points that are directly connected to a corresponding switch. The CDP may provide access to a summary of protocol and address information of the directly connected access points. The discovery data may include, for example, CDP data. The CDP data may include, for example, at least one of: a device name or a location identifier, of each switch and each access point connected to a corresponding switch. The CDP data may further include additional access point information, for example, operating system version number, hardware platform, native Virtual LAN (VLAN) ID, duplex setting, port ID, hardware capabilities, layer 3 address or IP address of the access point, interface that generates CDP messages, number of seconds for validity of CDP advertisements, name of the access point configured with a hostname, or the like. In more embodiments, the signal data including, for example, RSSI data, may be associated with the access points. In additional embodiments, the access points may include isolated access points that may not appear on an RSSI list. The RSSI list may include a collection of measurements that indicate strength of received radio signals from the access points.

In further embodiments, the process 700 may classify a plurality of access points into a set of clusters (block 720). The process 700 may classify the plurality of access points into a set of clusters based on the received discovery data and the received signal data. In still more embodiments, the process 700 may perform unsupervised machine learning to classify the plurality of access points into the set of clusters. By way of a non-limiting example, in still further embodiments, the process 700 may employ an advanced community detection algorithm such as the Leiden algorithm to identify the set of clusters with high precision. The Leiden algorithm may implement a method for community detection that improves on the Louvain method by ensuring better connectivity and quality of clusters. The Leiden algorithm may cluster data values such that the MSE of all data values within a given cluster may be minimized. Through the iterative reassignment of data points to different clusters to optimize overall modularity, the Leiden algorithm may enhance the precision of the floor identification. In still additional embodiments, a cluster of the set of clusters may correspond to one of the floors of the space. In some more embodiments, the set of clusters is connected by one or more weighted edges. In yet various embodiments, the one or more weighted edges, to which weights are assigned, may refer to the connections of the access points between respective clusters. In yet more embodiments, the weights may be assigned based on strength of the RSSI values reported by the access points in adjacent clusters.

In still yet more embodiments, the process 700 may determine a sequence of one or more floors in the space (block 730). The process 700 may determine the sequence of the one or more floors in the space based on the set of clusters. In many further embodiments, the process 700 may determine the sequence of the one or more floors based on the weights of the one or more weighted edges connecting the set of clusters. In many additional embodiments, the process 700 may calculate inner weights for each cluster, which may represent the strength of connections among the access points connected in the same cluster. In still yet further embodiments, the process 700 may further calculate inter weights between different clusters based on RSSIs reported by connected access points of a cluster with access points of another cluster. This connectivity matrix may facilitate the identification of linked clusters. In still yet additional embodiments, the inner weight calculation may determine the connectivity weight between different floors, enabling the identification of neighboring floors in a sequence.

In several embodiments, prior to determining the sequence of the one or more floors, the process 700 may validate the set of clusters. In several more embodiments, the set of clusters may be validated based on a variance value between the set of clusters and a variance value within the set of clusters. By way of a non-limiting example, in numerous embodiments, the process 700 may utilize a variance ration criterion such as the CHI for validating the set of clusters. The process 700 may calculate the CHI based on a between-group dispersion matrix and a within-cluster dispersion matrix. The between-group dispersion matrix may measure how much the clusters differ from each other. The within-cluster dispersion matrix may measure how much the data points within a single cluster differ, where the data points represent the access points. A higher CHI value may indicate a model with better defined clusters. The high CHI value may signify that the clusters are well separated (high variance between clusters) and the data points within each cluster are like each other (low variance within clusters). In numerous additional embodiments, the process 700 may determine the number of floors in the space based on a count of clusters in the set of clusters.

In further additional embodiments, the process 700 may allocate a floor-level identifier to at least one access point of the plurality of access points (block 740). The process 700 may allocate the floor-level identifier to at least one access point based on the determined sequence. The result of the Leiden algorithm may provide a partitioning of the switches in the building and their directly connected access points into distinct clusters where each cluster can correspond to a unique floor, for example, based on RSSI reporting. The CHI value helps in assessing whether these partitions are meaningful and well-defined. For example, a high CHI value would suggest that the clustering of two switches into one floor, and three switches into another floor, represents a clear floor structure, where the switches on different floors may be placed into different clusters. In many embodiments, the process 700 may determine the final number of floors by the following exemplary formula, where CDPs represent the switches:

$$Number of Floors = arg max \{ CHI\_n \} for : 1 <= n <= max number of CDPs$$

Further, inter edge weights between final clusters can indicate if a cluster is linked to another cluster. Decreasing weight would indicate an increasing distance between clusters and in turn difference in floor levels. By verifying the edge weights, the process 700 may obtain a vertical ordering of floors and assign a floor-level ID to each floor as per the order. Further, the process 700 may allocate the floor-level ID to all switches and access points in a cluster mapped to a floor based on the order. In a number of embodiments, the process 700 may assign a floor-level ID to each access point, facilitating the creation of a vertical order in the floor levels.

In a variety of embodiments, the process 700 may transmit the allocated floor-level ID to the at least one access point (block 750). In various embodiments, the process 700 may transmit an indication of the floor-level identifier allocated to each access point deployed at the appropriate floor. In more embodiments, the allocation of the access points to appropriate floors based on their floor-level IDs may enhance precision of indoor positioning and floor-level localization for various applications. For example, the allocation of an access point to a particular floor based on its floor-level ID may allow for easier troubleshooting and maintenance. In another example, if multiple access points are installed across different floors, identifying their locations can help distribute network traffic more uniformly and ensure that no single access point is overloaded. In a further example, the allocation of an access point to a particular floor based on its floor-level ID may allow users of client devices to troubleshoot connection issues. In an additional example, identifying access points by their floor-level IDs can help in enforcing security policies, such as restricting access to certain floors in the space.

Although a specific embodiment for a process 700 for floor-level allocation of network devices suitable for carrying out the various steps, processes, methods, and operations described herein is discussed with respect to FIG. 7, any of a variety of systems and/or processes may be utilized in accordance with embodiments of the disclosure. For example, in addition to or other than the CDP, other data link layer network protocols such as the link layer discovery protocol, an extreme discovery protocol, the link layer topology discovery protocol, or the like, may be implemented for providing discovery data utilized for classifying the access points into a set of clusters. The elements depicted in FIG. 7 may also be interchangeable with other elements of FIGS. 1-6 and FIGS. 8-11 as required to realize a particularly desired embodiment.

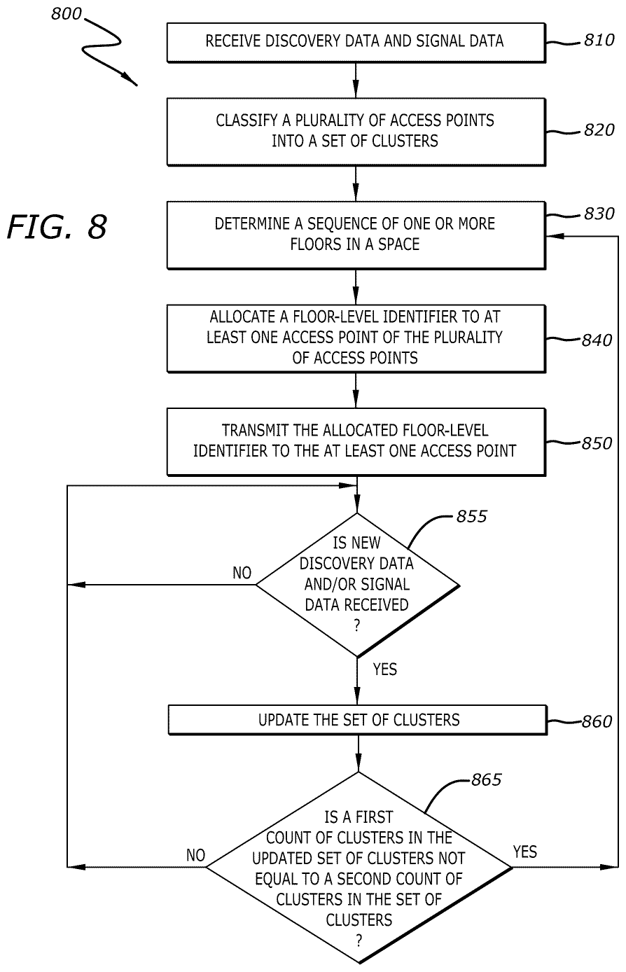

Referring to FIG. 8, a flowchart depicting a process 800 for iterative floor-level allocation of network devices in accordance with various embodiments of the disclosure is shown. In many embodiments, the network devices may include access points deployed across one or more floors of a space, for example, an indoor space such as a building. One or more of the access points may be connected to a set of switches deployed across one or more floors of the space. In a number of embodiments, the access points may provide their own signal data, for example, RSSI data, and signal data associated with neighboring access points. In one or more embodiments, the access points may provide their discovery data. In further embodiments, the switches may provide discovery data associated with the access points.

In a variety of embodiments, the process 800 may receive discovery data and signal data (block 810). In several embodiments, the discovery data may be received from the switches to which the access points deployed across one or more floors in the space, are connected. In several other embodiments, the discovery data may be received from the access points directly connected to corresponding switches. In various embodiments, the switches may be configured to implement a CDP. The CDP may refer to a layer 2 management protocol for networks, that facilitates collection of information of the access points that are directly connected to a corresponding switch. The discovery data may include, for example, CDP data. The CDP data may include, for example, at least one of: a device name or a location identifier, of each switch and each access point connected to a corresponding switch. In more embodiments, the signal data including, for example, RSSI data, may be associated with the access points. In additional embodiments, the access points may include isolated access points that may not appear on an RSSI list.

In further embodiments, the process 800 may classify a plurality of access points into a set of clusters (block 820). The process 800 may classify the plurality of access points into a set of clusters based on the received discovery data and the received signal data. In still more embodiments, the process 800 may perform unsupervised machine learning to classify the plurality of access points into the set of clusters. By way of a non-limiting example, in still further embodiments, the process 800 may employ an advanced community detection algorithm such as the Leiden algorithm to identify the set of clusters with high precision. In still additional embodiments, a cluster of the set of clusters may correspond to one of the floors of the space. In some more embodiments, the set of clusters is connected by one or more weighted edges. In yet various embodiments, the one or more weighted edges, to which weights are assigned, may refer to the connections of the access points between respective clusters. In yet more embodiments, the weights may be assigned based on strength of the RSSI values reported by the access points in adjacent clusters.

In still yet more embodiments, the process 800 may determine a sequence of one or more floors in a space (block 830). The process 800 may determine the sequence of the one or more floors in the space based on the set of clusters. In many further embodiments, the process 800 may determine the sequence of the one or more floors based on the weights of the one or more weighted edges connecting the set of clusters. In many additional embodiments, prior to determining the sequence of the one or more floors, the process 800 may validate the set of clusters. In still yet further embodiments, the set of clusters may be validated based on a variance value between the set of clusters and a variance value within the set of clusters. By way of a non-limiting example, in still yet additional embodiments, the process 800 may utilize a variance ration criterion such as the CHI for validating the set of clusters.

In several embodiments, the process 800 may allocate a floor level identifier to at least one access point of the plurality of access points (block 840). The process 800 may allocate the floor-level identifier to at least one access point based on the determined sequence. The result of the Leiden algorithm may provide a partitioning of the switches in the building and their directly connected access points into distinct clusters where each cluster can correspond to a unique floor, for example, based on RSSI reporting. The CHI value helps in assessing whether these partitions are meaningful and well-defined. In several more embodiments, the process 800 may determine the final number of floors by the following exemplary formula, where CDPs represent the switches:

$$Number of Floors = arg max \{ CHI\_n \} for : 1 <= n <= max number of CDPs$$

Further, inter edge weights between final clusters can indicate if a cluster is linked to another cluster. Decreasing weight would indicate an increasing distance between clusters and in turn difference in floor levels. By verifying the edge weights, the process 800 may obtain a vertical ordering of floors and assign a floor-level ID to each floor as per the order. Further, the process 800 may allocate the floor-level ID to all switches and access points in a cluster mapped to a floor based on the order. In numerous embodiments, the process 800 may assign a floor-level ID to each access point, facilitating the creation of a vertical order in the floor levels.

In numerous additional embodiments, the process 800 may transmit the allocated floor level identifier to the at least one access point (block 850). In further additional embodiments, the process 800 may transmit an indication of the floor-level identifier allocated to each access point deployed at the appropriate floor. In many embodiments, the allocation of the access points to appropriate floors based on their floor-level IDs may enhance precision of indoor positioning and floor-level localization for various applications. For example, if multiple access points are installed across different floors, identifying their locations can help distribute network traffic more uniformly and ensure that no single access point is overloaded. In a further example, the allocation of an access point to a particular floor based on its floor-level ID may allow users of client devices to troubleshoot connection issues. In an additional example, identifying access points by their floor-level IDs can help in enforcing security policies, such as restricting access to certain floors in the space.

In a number of embodiments, the process 800 may determine whether new discovery data and/or signal data is received (block 855). When new access points are connected to the switches deployed across one or more floors, reclassification of the access points into an updated set of clusters may be required. In a variety of embodiments, the process 800 may implement the CDP to determine new discovery data, that is, CDP data, indicative of new access points directly connected to each switch. In various embodiments, the process 800 may periodically transmit requests to the switches for the latest discovery data. In more embodiments, the process 800 may periodically transmit requests to the access points for the latest signal data that may include, for example, RSSI data. In additional embodiments, the access points can be configured to automatically transmit notifications to a controller whenever there is an update in the CDP data or the RSSI data. The process 800 may collect data from the access points at regular intervals, timestamping each data point. By comparing new data against the previously recorded values, the process 800 may determine whether new discovery data and/or signal data is been received.

In response to determining that new discovery data and/or signal data is not received, in further embodiments, the process 800 may continue determining whether new discovery data and/or signal data is received (block 855). In still more embodiments, the process 800 may iteratively check for new discovery data and/or signal data based on different criteria. For example, the process 800 may iteratively check for new discovery data and/or signal data based on polling defined by the controller. In another example, the process 800 may iteratively check for new discovery data and/or signal data based on notifications about substantial changes to RSSI values or CDP metrics against predefined thresholds.

In response to determining that new discovery data and/or signal data is received, in still further embodiments, the process 800 may update the set of clusters (block 860). The process 800 may update the set of clusters based on the new discovery data and the new signal data. In still additional embodiments, the process 800 may perform unsupervised machine learning to reclassify the plurality of access points into an updated set of clusters. By way of a non-limiting example, in some more embodiments, the process 800 may employ an advanced community detection algorithm such as the Leiden algorithm to identify the updated set of clusters with high precision.

In yet various embodiments, the process 800 may determine whether a first count of clusters in the updated set of clusters is not equal to a second count of clusters in the set of clusters (block 865). The process 800 may determine whether the first count of clusters in the updated set of clusters is different from the second count of clusters in the set of clusters. The process 800 may count the clusters after the first classification and after the reclassification to determine the second count of clusters and the first count of clusters, respectively. The process 800 may then compare the first count of clusters and the second count of clusters to determine whether the first count of clusters in the updated set of clusters is not equal to the second count of clusters in the set of clusters. In yet more embodiments, the process 800 may obtain the first count of clusters and the second count of clusters from the output of the unsupervised machine learning algorithm, for example, the Leiden algorithm.

In response to determining that a first count of clusters in the updated set of clusters is equal to a second count of clusters in the set of clusters, the process 800 may proceed to determine whether new discovery data and/or signal data is received (block 855). In still yet more embodiments, the process 800 may implement the CDP to determine new discovery data, that is, CDP data, indicative of new access points directly connected to each switch. In many further embodiments, the process 800 may periodically transmit requests to the switches for the latest discovery data. In many additional embodiments, the process 800 may periodically transmit requests to the access points for the latest signal data that may include, for example, RSSI data. In still yet further embodiments, if the process 800 determines that a first count of clusters in the updated set of clusters is equal to a second count of clusters in the set of clusters, the process 800 may conclude that the number of floors is unchanged and that the new access points were directly connected to the switches on their previously allocated floor levels.

In response to determining that a first count of clusters in the updated set of clusters is not equal to a second count of clusters in the set of clusters, the process 800 may proceed to determine a sequence of one or more floors in the space (block 830). The process 800 may determine the sequence of the one or more floors in the space based on the updated set of clusters. The process 800 may update the sequence of the one or more floors based on the determination that the first count of clusters is different from the second count of clusters. In still yet additional embodiments, the process 800 may determine the sequence of the one or more floors based on the weights of the one or more weighted edges connecting the set of clusters as disclosed above. In several embodiments, the process 800 may then allocate a new floor-level identifier to each the newly added access points based on the updated sequence.

Although a specific embodiment for a process 800 for iterative floor-level allocation of network devices suitable for carrying out the various steps, processes, methods, and operations described herein is discussed with respect to FIG. 8, any of a variety of systems and/or processes may be utilized in accordance with embodiments of the disclosure. For example, an alternative index such as the Davies-Bouldin index may be utilized for measuring the average similarity ratio of each cluster with the cluster most similar to it. Lower values indicate better clustering. In several embodiments, the process 800 may infer the appropriate number of clusters by evaluating the Davies-Bouldin index for different cluster counts. In several more embodiments, other indexes such as the silhouette width, the Dunn index, the adjusted Rand index, the Xie-Beni index, or the like may also be utilized for validating the clusters. The elements depicted in FIG. 8 may also be interchangeable with other elements of FIGS. 1-7 and FIGS. 9-11 as required to realize a particularly desired embodiment.

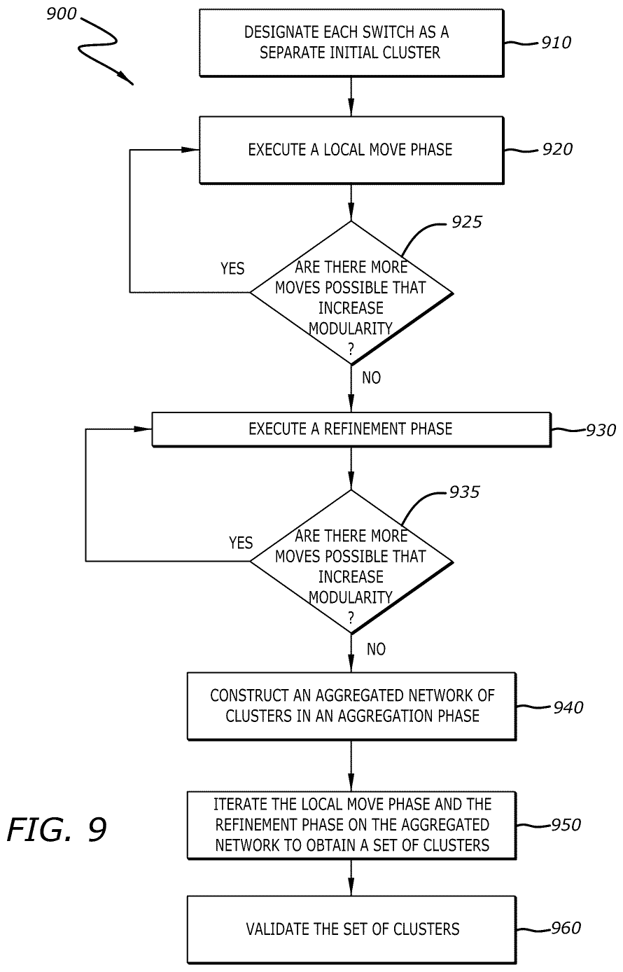

Referring to FIG. 9, a flowchart depicting a process 900 for classifying multiple access points into a set of clusters in accordance with various embodiments of the disclosure is shown. The process 900 may classify a massive number of access points deployed across one or more floors of a space, for example, an indoor space such as a building. One or more of the access points may be connected to a set of switches deployed across one or more floors of the space. In many embodiments, the access points may provide their own signal data, for example, RSSI data, and signal data associated with neighboring access points. In one or more embodiments, the access points may provide discovery data, for example, CDP data. In further embodiments, the switches may provide discovery data, for example, CDP data, associated with the access points. In a number of embodiments, the process 900 may apply the Leiden algorithm to classify the access points into a set of clusters. The Leiden algorithm may detect communities in networks and incorporate a refinement phase to enhance the quality of partitioning to ensure better connectivity and quality of clusters. By way of a non-limiting example, the steps of the Leiden algorithm are enumerated below.

In a variety of embodiments, the process 900 may designate each switch as a separate initial cluster (block 910). In an initialization phase, the process 900 may initialize a partition of a network by designating each switch as a cluster. In more embodiments, each switch may implement the CDP and may herein be referred to as a “CDP switch”. Initialization may be followed by a series of node movements and refinements to maximize modularity, and then aggregation of clusters may be performed to form a new, smaller network. Consider an example of a network with 10 nodes, where each node represents a CDP switch. In this example, the nodes may be connected as follows:
Node 1 is connected to Node 2, Node 3, and Node 4
Node 2 is connected to Node 1, Node 3, and Node 4
Node 3 is connected to Node 1, Node 2, and Node 4
Node 4 is connected to Node 1, Node 2, Node 3, and Node 5
Node 5 is connected to Node 4, Node 6, and Node 7
Node 6 is connected to Node 5 and Node 7
Node 7 is connected to Node 5, Node 6, Node 8, and Node 9
Node 8 is connected to Node 7, Node 9, and Node 10
Node 9 is connected to Node 7, Node 8, and Node 10
Node 10 is connected to Node 8 and Node 9

In the initialization phase, each node is its own cluster, resulting in 10 initial clusters as follows.
Initial clusters: {1}, {2}, {3}, {4}, {5}, {6}, {7}, {8}, {9}, {10}

In various embodiments, the process 900 may execute a Local Move Phase (block 920). The mathematical objective of the Leiden algorithm is to maximize a quality function known as modularity. Modularity Q is given by the formula:

$$Q = \frac{1}{2 m} * \sum ( {A}_{ij} - \frac{{k}_{i} * {k}_{j}}{2 m} ) * δ ( {c}_{{i}^{-}} {c}_{j} ) \qquad ( 3 )$$

where in (1):
“m” denotes the total weight of the edges in the network;
Aᵢⱼ denotes the weight of the edge between CDP switches i and j;
kᵢ and kⱼ denote the total edge weights connected to CDP switches i and j, respectively;
cᵢ and cⱼ denote the communities of CDP switches i and j, respectively; and
δ(cᵢ-cⱼ) denotes 1 if cᵢ=cⱼ, and 0 otherwise.

In the Local Move Phase, the process 900 may move the CDP switch to the cluster of its neighbors, and calculate how much this move improves the modularity (ΔQ). The CDP switch may move to a neighbor's cluster if the CDP switch increases modularity. For each CDP switch “i”, the process 900 may calculate the change in modularity ΔQ for moving “i” from its own cluster and placing it in the cluster of each of its neighbors. The process 900 may move “i” to the cluster for which ΔQ is maximized (but only if ΔQ>0). The process 900 may repeat the local moves until no moves are possible that increase modularity. The process 900 may generate new clusters after completing the Local Move Phase for the above example scenario as follows:
(a) Node 1 is connected to Node 2, Node 3, and Node 4. In an example, if moving Node 1 to the same cluster as Node 2 increases modularity the most, Node 1 is moved to Node 2's cluster. The process 900 may generate the following new clusters:
New Clusters: {1, 2}, {3}, {4}, {5}, {6}, {7}, {8}, {9}, {10}
(b) Node 3 is connected to Node 1, Node 2, and Node 4. Since Node 1 is now in the cluster of Node 2, moving Node 3 to their cluster increases modularity. Node 3, therefore, joins the cluster
{1, 2} to obtain the following new clusters:
New Clusters: {1, 2, 3}, {4}, {5}, {6}, {7}, {8}, {9}, {10}
(c) Node 4 is connected to Node 1, Node 2, and Node 3. Since they all belong to the same cluster, Node 4 joins the cluster {1, 2, 3} as well to obtain the following new clusters:
New Clusters: {1, 2, 3, 4}, {5}, {6}, {7}, {8}, {9}, {10}
(d) Node 5 is connected to Node 4, but it is not beneficial to join Node 4's cluster. However, there is an increase in modularity if Node 5 joins with Node 6. Node 5 and Node 6, therefore, form a cluster.
New Clusters: {1, 2, 3, 4}, {5, 6}, {7}, {8}, {9}, {10}
(e) Since Node 7 is connected to Node 5 and Node 6, Node 7 joins their cluster.
New Clusters: {1, 2, 3, 4}, {5, 6, 7}, {8}, {9}, {10}
(f) Node 8 is connected to Node 7, Node 9, and Node 10, and moves to the same cluster as node 7 to obtain the following new clusters:
New Clusters: {1, 2, 3, 4}, {5, 6, 7, 8}, {9}, {10}
(g) Node 9 joins Node 8's cluster to obtain the following new clusters:
New Clusters: {1, 2, 3, 4}, {5, 6, 7, 8, 9}, {10}
(h) Node 10 finally joins the cluster of Node 9 to obtain the following new clusters:
New Clusters: {1, 2, 3, 4}, {5, 6, 7, 8, 9, 10}

At the end of the Local Move Phase, the process 900 may obtain two large intermediate clusters as follows:
Cluster 1: {1, 2, 3, 4}; and
Cluster 2: {5, 6, 7, 8, 9, 10}

In additional embodiments, the process 900 may determine whether there are more moves possible that increase modularity (block 925). For each CDP switch, the process 900 may calculate the change in modularity ΔQ for moving the CDP switch from its own cluster and placing it in the cluster of each of its neighbors. The process 900 may move the CDP switch to the cluster for which ΔQ is maximized, only if ΔQ>0. The process 900 may repeat the local moves until no moves are possible that increase modularity.

In response to determining that there are more moves possible that increase modularity, in further embodiments, the process 900 may repeat execution of the Local Move Phase (block 920). The process 900 may evaluate the impact of moving a node on the overall modularity. As shown in the above example scenario, Node 2, Node 3, and Node 4 keep moving into Node 1's cluster to form the Cluster 1 until no moves are possible that increase modularity. Similarly, the Node 6, Node 7, Node 8, Node 9, and Node 10 keep moving into Node 5's cluster to form the Cluster 2 until no moves are possible that increase modularity.

However, in response to determining that there are no moves possible that increase modularity, in still more embodiments, the process 900 may execute a Refinement Phase (block 930). In the Refinement Phase, for each pair of clusters (C, C′), the process 900 may calculate the change in modularity ΔQ for moving a CDP switch from C and C′. In still further embodiments, the process 900 may move entire access points of one CDP switch for which ΔQ is maximized but only if ΔQ>0. The process 900 may repeat the Refinement Phase until no moves are possible that increase modularity.

In still additional embodiments, the process 900 may determine whether there are more moves possible that increase modularity (block 935). In the Refinement Phase, the process 900 may attempt to refine the partitions by considering entire clusters and determining whether moving the clusters together would increase modularity. This step may ensure that the clusters are internally connected. In the above example scenario, for each pair of communities, the process 900 may compare Cluster 1 {1, 2, 3, 4} and Cluster 2 {5, 6, 7, 8, 9, 10}. If moving nodes or small subclusters between the clusters increases modularity, the process 900 performs the move. However, in this example scenario, since both clusters are internally connected and well-separated, no moves occur and therefore no changes are made in this refinement step.

In response to determining that there are more moves possible that increase modularity, the process 900 may repeat execution of the Refinement Phase (block 930). This repetition may further the refine the partitions by considering entire clusters and determining whether moving the clusters together would increase modularity. If moving nodes or small subclusters between the clusters increases modularity, the process 900 performs the move. The process 900 may repeat the Refinement Phase until no moves are possible that increase modularity.

However, in response to determining that there are no more moves possible that increase modularity, the process 900 may construct an aggregated network of clusters in an Aggregation Phase (block 940). In the Aggregation Phase, the process 900 may construct a new network where each partition from the last two steps, which may have one or more CDP switches, represents a cluster in the current partition, and edges between partitions are the sum of the edges between their corresponding clusters. In the above example scenario, the process 900 may aggregate the clusters as follows. The process 900 may treat Cluster 1 {1, 2, 3, 4} and Cluster 2 {5, 6, 7, 8, 9, 10} as individual nodes in the new network. In this new network, the edges between these nodes may represent the sum of the edges between the initial clusters. The process 900 has now formed a reduced network with two super nodes, each representing a cluster from the previous step as follows:
Super Node A represents {1, 2, 3, 4}
Super Node B represents {5, 6, 7, 8, 9, 10}

The edge between the supper nodes may represent the total number of edges between the nodes in the super node A and the super node B. In some more embodiments, the process 900 may iterate the Local Move Phase and the Refinement Phase on the aggregated network to obtain a set of clusters (block 950). That is, the process 900 may repeat the local move and refinement phases on the new aggregated network until no further improvement in modularity can be made. In the above example scenario, the process 900 may repeat the local move and refinement phases on the two super nodes, Super Node A and Super Node B. Since there are only two super nodes, and no further moves can increase modularity, the process 900 may terminate the iterations. Further, in the above example, scenario, after several iterations of local moves, refinements, and aggregation, the final clustering reveals the following two distinct final clusters:
Final Cluster 1: {1, 2, 3, 4}; and
Final Cluster 2: {5, 6, 7, 8, 9, 10}

The final clusters are well-separated and internally connected, resulting in a high modularity score.

In yet various embodiments, the process 900 may validate the set of clusters (block 960). In yet more embodiments, the process 900 may validate the set of clusters by utilizing a variance ratio criterion, for example, the CHI. The process 900 may calculate the CHI by utilizing the following formula:

$$CHI = \frac{[ \frac{B}{K - 1} ]}{[ \frac{W}{N - K} ]}$$

Where:
B denotes the between-group dispersion matrix which measures how much the clusters differ from each other. The between-group dispersion matrix is the sum of squared distances between the cluster centers and the center of gravity of all samples (i.e., the mean vector of the data points); W denotes the within-cluster dispersion matrix which measures how much the data points within a single cluster differ. The within-cluster dispersion matrix is the sum of squared distances of samples to their respective cluster centers;
K denotes the number of clusters; and
N denotes the total number of samples.

The numerator in the above formula is the between-group mean square, representing the variance between clusters. The denominator in the above formula is the within-cluster mean square, representing the variance within clusters. The CHI may refer to a ratio of the between-group variance to the within-group variance. A higher CHI value indicates a model with better defined clusters. The high CHI value may signify that the clusters are well separated (high variance between clusters) and the data points within each cluster are like each other (low variance within clusters).

In an example where there is more than one CDP switch per floor, to ensure that multiple CDP switches share the same floor-level ID and that the floor-level ID is consistent across all access points connected to those CDP switches, the process 900 may execute the following steps. The process 900 may first initialize the network by designating each CDP switch as an initial cluster ID, herein referred to as a “floor-level ID”. The process 900 may then assign floor-level IDs to the access points to ensure that all access points connected to these CDP switches share the same floor-level ID. The process 900 may then update and maintain floor-level IDs by ensuring that any update to the floor-level ID is propagated to all relevant CDP switches and their connected access points by utilizing RSSI data. In yet more embodiments, the process 900 may avoid moving access points between CDP switches unless the entire floor-level ID is updated when one or more CDP data is combined. The process 900 may then refine the configuration of the network by performing node movements and refinements to maximize modularity while maintaining floor-level ID consistency.

After determining the exact floor where the access points are located, in still yet more embodiments, the process 900 may employ a combination of Global Navigation Satellite System (GNSS) raw data and ranging Fine Timing Measurement (FTM) data to position the access points onto a floor map with precision. The GNSS raw data may include, for example, a time of measurement, satellite pseudoranges measured between a satellite and a GNSS receiver, their standard deviations, carrier phase, Doppler shifts, or the like. Distance measurement between access points or ranging may be performed by utilizing FTM or precise time measurements. GNSS raw data may be collected from access points located on the perimeter of the building ensuring optimal azimuthal coverage or skyview. Using the inter-access point distances measured by FTM, these access points may be utilized as anchors in the positioning process, facilitating the precise positioning of other access points that lack GNSS receivers or suffer from inadequate satellite coverage. In scenarios where GNSS reception is unavailable or insufficient, the process 900 may utilize ranging data to calculate the relative positions of the access points, ensuring accuracy and reliability in access point localization across diverse environmental conditions. Further, a drag-and-drop functionality may be provided on a localization application deployed on a client device, allowing users to fine-tune an access point constellation directly on a floor map interface.

Although a specific embodiment for a process 900 for classifying multiple access points into a set of clusters suitable for carrying out the various steps, processes, methods, and operations described herein is discussed with respect to FIG. 9, any of a variety of systems and/or processes may be utilized in accordance with embodiments of the disclosure. For example, at the initialization phase, the process 900 may start with a more informed initial community structure, for example, by utilizing prior clustering results or algorithms such as spectral clustering, to reduce the number of iterations needed. The elements depicted in FIG. 9 may also be interchangeable with other elements of FIGS. 1-8, FIG. 10, and FIG. 11 as required to realize a particularly desired embodiment.

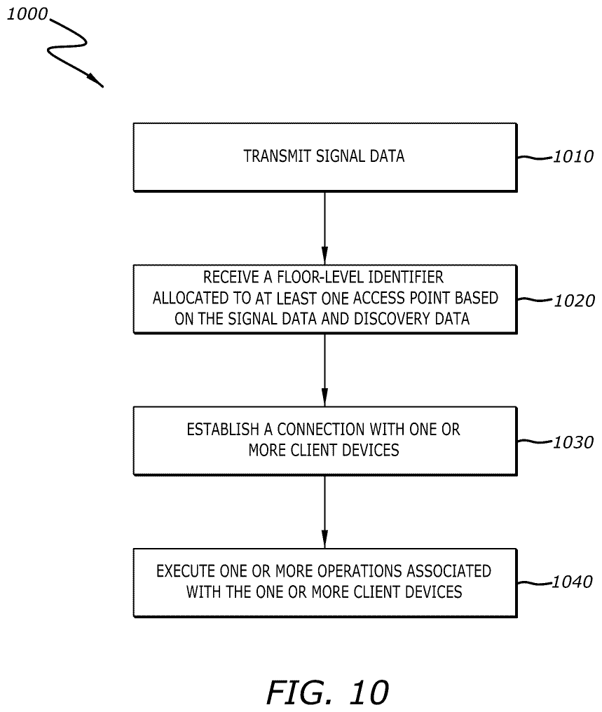

Referring to FIG. 10, a flowchart depicting a process 1000 for executing one or more operations based on floor-level allocation of network devices in accordance with various embodiments of the disclosure is shown. Floor-level localization of client devices may refer to determining and tracking a specific floor or level within a space, for example, a multistory building, where a client device such as a smartphone, a laptop, a personal digital assistant, a wearable device, or the like, is located. Multiple access points may be disposed at one or more floors of the space. These access points may be directly connected to corresponding switches deployed across one or more floors of the space.

In many embodiments, the process 1000 may transmit signal data (block 1010). In a number of embodiments, the signal data may include RSSI data associated with the access points. In a variety of embodiments, the process 1000 may transmit the signal data and the discovery data from each of the access points to a controller. The discovery data may indicate an association of a switch and the access point and a plurality of other access points that are deployed across one or more floors in the space. In various embodiments, the access points may provide their own signal data and signal data associated with neighboring access points. The controller may be operably coupled to each switch. In more embodiments, the access points may include fixed access points that are connected to the controller 110 via their corresponding switches. In further embodiments, the switches may be configured to implement a CDP.

In additional embodiments, the process 1000 may receive a floor-level identifier allocated to at least one access point based on the signal data and the discovery data (block 1020). The floor-level identifier may be allocated to at least one access point based on a sequence of the one or more floors in the space. The sequence of the one or more floors in the space may be determined based on a set of clusters into which the access points may be classified by utilizing the signal data and the discovery data. The result of the Leiden algorithm utilized for classifying the access points into a set of clusters may provide a partitioning of the switches in the building and their directly connected access points into distinct clusters where each cluster can correspond to a unique floor, for example, based on RSSI reporting.

In still more embodiments, the process 1000 may establish a connection with one or more client devices (block 1030). The process 1000 may establish a connection between the access point allocated with the floor-level identifier and the client device(s). In still further embodiments, the access point may broadcast its Service Set Identifier (SSID) to allow the client device(s) to connect to the access point and access a wireless network. In still additional embodiments, the access point may broadcast floor information to help client devices recognize to which floor they are connecting. The client device(s) may transmit a connection request to the selected access point. The access point may authenticate the client device using configured security protocols. If authentication is successful, the access point may transmit an association response back to the client device(s), confirming the connection.

In some more embodiments, the process 1000 may execute one or more operations associated with the one or more client devices (block 1040). In one or more embodiments, the process 1000 may localize the one or more client devices. In yet various embodiments, the process 1000 may utilize a combination of the RSSI data and the discovery data for estimating the vertical position of the client device(s) within the space. In yet more embodiments, the process 1000 may localize the client device(s) by measuring the signal strength of the connection between the access point and the client device(s). In still yet more embodiments, the process 1000 may execute a fingerprinting method that involves creating a map of Wi-Fi® signal strengths at various known locations on the floor. When the client device connects to the access point, the access point may compare the current RSSI readings against the pre-recorded fingerprints to determine an approximate location of the client device(s). If there are multiple access points on the same floor, the access point to which the client device is connected, may utilize triangulation or trilateration to determine an approximate location of the client device(s). By measuring the signal strength from several access points and knowing their locations on the floors of the space, the access point or the controller may triangulate the position of the client device.

In many further embodiments, the process 1000 may transmit measurement data to a location engine deployed, for example, at a location server, a mobility services engine, a cloud-based platform for location services, or the like, for localization of the client device. In many additional embodiments, the process 1000 may transmit a mapping of the access point to the floor-level identifier to several access points and other network entities for further processing including, for example, generating roaming recommendations, generating 802.11k neighbor reports, or the like.

Although a specific embodiment for a process 1000 for executing one or more operations based on floor-level allocation of network devices suitable for carrying out the various steps, processes, methods, and operations described herein is discussed with respect to FIG. 10, any of a variety of systems and/or processes may be utilized in accordance with embodiments of the disclosure. For example, the access points may be roaming access points that are connected to the controller through wireless connections. The elements depicted in FIG. 9 may also be interchangeable with other elements of FIGS. 1-9 and FIG. 11 as required to realize a particularly desired embodiment.

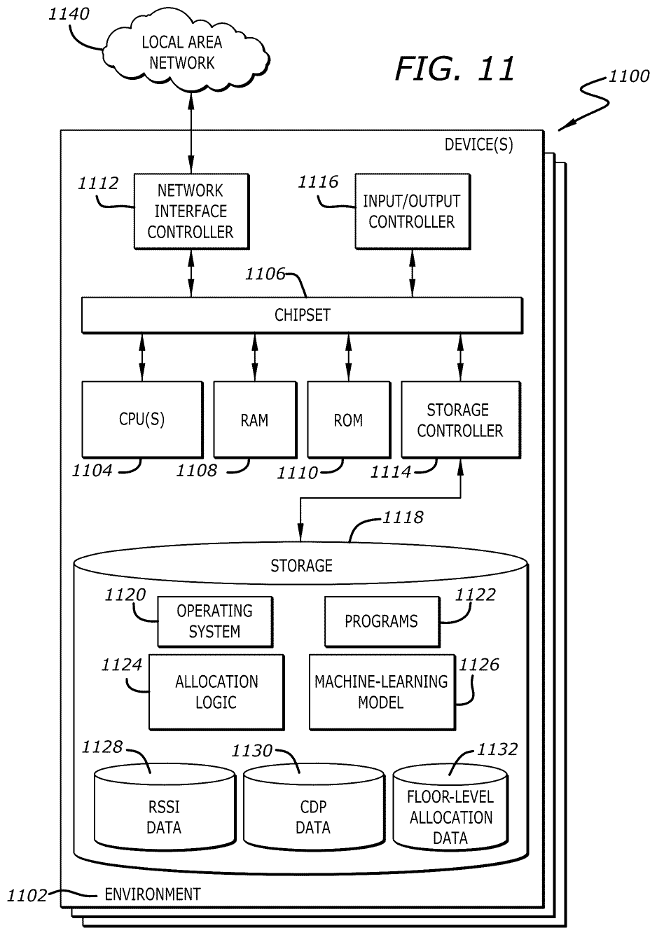

Referring to FIG. 11, a conceptual block diagram of a device 1100 capable of executing components and an allocation logic 1124 for implementing the functionality and embodiments described above is shown. The embodiment of the conceptual block diagram depicted in FIG. 11 can illustrate a conventional server computer, a workstation, a desktop computer, a laptop, a tablet, a network appliance, an electronic reader (e-reader), a smartphone, or other computing device, and can be utilized to execute any of the application and/or logic components presented herein. The device 1100 may, in some examples, correspond to a physical device or to a virtual resource described herein. The device 1100 can be a network device (for example, an access point, a switch, or a controller), a client device, or the like in accordance with various embodiments of the disclosure.

In many embodiments, the device 1100 may include an environment 1102 such as a baseboard or a “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In a number of embodiments, one or more processors 1104, such as, but not limited to, central processing units (CPUs) can be configured to operate in conjunction with a chipset 1106. The processor(s) 1104 can be standard programmable CPUs that perform arithmetic and logical operations necessary for the operation of the device 1100.

In a variety of embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1106 may provide an interface between the processor(s) 1104 and the remainder of the components and devices within the environment 1102. The chipset 1106 can provide an interface to a random-access memory (RAM) 1108, which can be utilized as the main memory in the device 1100 in some embodiments. The chipset 1106 can further be configured to provide an interface to a computer-readable storage medium such as a read-only memory (ROM) 1110 or a Non-Volatile RAM (NVRAM) for storing basic routines that can help with various tasks such as, but not limited to, starting up the device 1100 and/or transferring information between the various components and devices. The ROM 1110 or NVRAM can also store other application components necessary for the operation of the device 1100 in accordance with various embodiments described herein.

Different embodiments of the device 1100 can be configured to operate in a networked environment using logical connections to remote computing devices and computer systems through a network, such as the network 1140. The chipset 1106 can include functionality for providing network connectivity through a Network Interface Controller (NIC) 1112, which may include a gigabit Ethernet adapter or similar component. The NIC 1112 can be capable of connecting the device 1100 to other devices over the network 1140. It is contemplated that multiple NICs 1112 may be present in the device 1100, connecting the device 1100 to other types of networks and remote systems.

In more embodiments, the device 1100 can be connected to a storage 1118 that provides non-volatile storage for data accessible by the device 1100. The storage 1118 can, for example, store an operating system 1120, programs 1122, RSSI data 1128, CDP data 1130, and floor-level allocation data 1132, which are described in greater detail below. The storage 1118 can be connected to the environment 1102 through a storage controller 1114 connected to the chipset 1106. In additional embodiments, the storage 1118 can include one or more physical storage units. The storage controller 1114 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 1100 can store data within the storage 1118 by transforming the physical state of the physical storage units to reflect the information being stored. The specific transformation of physical state can depend on various factors. Examples of such factors can include, but are not limited to, the technology utilized to implement the physical storage units, whether the storage 1118 is characterized as primary or secondary storage, and the like. For example, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1100 can further read or access information from the storage 1118 by detecting the physical states or characteristics of one or more particular locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, the operations performed by a cloud computing network, and or any components included therein, may be supported by one or more devices similar to the device 1100. Stated otherwise, some or all of the operations performed by the cloud computing network, and or any components included therein, may be performed by one or more devices 1100 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, Erasable programmable ROM (EPROM), Electrically-Erasable programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1118 can store an operating system 1120 utilized to control the operation of the device 1100. According to one embodiment, the operating system 1120 includes the LINUX operating system. According to another embodiment, the operating system 1120 includes the Windows® server operating system from Microsoft Corporation of Redmond, Washington. According to further embodiments, the operating system 1120 can include the UNIX operating system or one of its variants. It should be appreciated that other operating systems can also be utilized. The storage 1118 can store other system or application programs and data utilized by the device 1100.

In still more embodiments, the storage 1118 or other computer-readable storage media is encoded with computer-executable instructions which, when loaded into the device 1100, may transform the device 1100 from a general-purpose computing system into a special-purpose computer capable of implementing the embodiments described herein. These computer-executable instructions may be stored as r programs 1122 (e.g., applications) and transform the device 1100 by specifying how the processor(s) 1104 can transition between states, as described above. In still further embodiments, the device 1100 has access to computer-readable storage media storing computer-executable instructions which, when executed by the device 1100, perform the various processes described above with regard to FIGS. 1-11. In still additional embodiments, the device 1100 can also include computer-readable storage media having instructions stored thereupon for performing any of the other computer-implemented operations described herein.

In some more embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 may not include all of the components shown in FIG. 11, and can include other components that are not explicitly shown in FIG. 11, or may utilize an architecture completely different than that shown in FIG. 11.

As described above, the device 1100 may support a virtualization layer, such as one or more virtual resources executing on the device 1100. In some examples, the virtualization layer may be supported by a hypervisor that provides one or more virtual machines running on the device 1100 to perform functions described herein. The virtualization layer may generally support a virtual resource that performs at least a portion of the techniques described herein.

In yet various embodiments, the device 1100 can include an allocation logic 1124 that may be responsible for floor-level allocation of network devices, for example, access points. In yet more embodiments, the allocation logic may operate in the controller. In embodiments where the device 1100 corresponds to the controller, the allocation logic 1124 can be configured to perform various operations such as, but not limited to, receiving discovery data and signal data; classifying the access points into a set of clusters based on the received discovery data and the received signal data; determining a sequence of one or more floors based on the set of clusters; and allocating a floor-level identifier to at least one access point based on the determined sequence. In embodiments where the device 1100 corresponds to a network device, for example, an access point, the allocation logic 1124 can be configured to perform various operations such as, but not limited to, transmit signal data and discovery data and receive a floor-level identifier allocation based on the transmitted signal data and the transmitted discovery data.

Those skilled in the art will recognize that the allocation logic 1124 can include various hardware and/or software deployments and can be configured in a variety of ways. In still yet more embodiments, the allocation logic 1124 can be configured as a standalone device, exist as a logic in another network device, be distributed among various network devices operating in tandem, or remotely operated as part of a cloud-based network management tool. In many further embodiments, one or more servers can be configured with the allocation logic 1124 or can otherwise operate as the allocation logic 1124. In many additional embodiments, the allocation logic 1124 may operate on one or more servers connected to a communication network, for example, the Internet. The communication network can include wired networks or wireless networks. The allocation logic 1124 can be provided as a cloud-based service that can service remote networks, such as, but not limited to a deployed network. Further, in still yet further embodiments, the allocation logic 1124 may be operated as a distributed logic across multiple network devices. In an embodiment, the control plane node can operate as the allocation logic 1124 or may have multiple devices operate as the allocation logic 1124 in a distributed manner.

In several embodiments, the storage 1118 can include signal data, for example, RSSI data 1128. The RSSI data 1128 may relate to data representative of strength of signals transmitted by the access points and received by client devices. For example, the RSSI data 1128 may include measurements of power levels or signal strengths of received radio signals. The RSSI data may allow the client devices to determine the quality of their connections with the access points, assess their proximity to the access points, and make decisions about network connectivity or roaming. In further additional embodiments, the RSSI data 1128 may be utilized by the allocation logic 1124 to classify the access points into a set of clusters.

In several more embodiments, the storage 1118 can include discovery data, for example, CDP data 1130. The CDP data 1130 may relate to data representative of all access points connected to the switches. In one or more embodiments, the CDP data 1130 may relate to data representative of the switches. The CDP data 1130 can include, but is not limited to, a device name or a location identifier such as an IP address, of each switch and each access point connected to each switch deployed across the floors of a building. The CDP data 1130 can also include, but is not limited to, a summary of protocol and address information of the directly connected access points. The CDP data 1130 can also include, but is not limited to, additional access point information, for example, operating system version number, hardware platform, native VLAN ID, duplex setting, port ID, hardware capabilities, layer 3 address or IP address of the access point, interface that generates CDP messages, number of seconds for validity of CDP advertisements, name of the access point configured with a hostname, or the like. In several embodiments, in addition to the RSSI data, the CDP data 1130 may be utilized by the allocation logic 1124 to classify the access points into a set of clusters.

In numerous embodiments, the storage 1118 can include floor-level allocation data 1132. The floor-level allocation data 1132 may relate to data representative of the set of clusters into which the access points are classified. For example, the floor-level allocation data 1132 may include RSSI data, CDP data, cluster data, connectivity weight data, a sequence of the floors determined based on the set of clusters, and a floor-level identifier allocated to at least one access point based on the determined sequence.

In numerous additional embodiments, data may be processed into a format usable by a machine-learning (“ML”) model 1126 (e.g., feature vectors), and or other pre-processing techniques. The ML model 1126 may be any type of ML model, such as supervised models, reinforcement models, and/or unsupervised models. The ML model 1126 may include one or more of linear regression models, logistic regression models, decision trees, Naïve Bayes models, neural networks, k-means cluster models, random forest models, and/or other types of ML models. The ML model 1126 may be configured to analyze the RSSI data 1128, the CDP data 1130, and the floor-level allocation data 1132 for performing floor-level allocation of the access points and localization. In further additional embodiments, the ML model 1126 may be utilized to identify various parameters to include in the RSSI data 1128, the CDP data 1130, and the floor-level allocation data 1132. For example, the ML model 1126 may analyze the RSSI data 1128, the CDP data 1130, and the floor-level allocation data 1132 and identify parameters that are required to augment the RSSI data 1128, the CDP data 1130, and the floor-level allocation data 1132. Once the parameters are identified, the allocation logic 1124 may utilize the parameters to perform floor-level allocation of the access points and localization. For example, the ML model 1126 may be configured to receive the RSSI data and the CPD data. The allocation logic 1124 may then utilize trained models to classify the access points into a set of clusters based on the RSSI data and the CDP data, determine a sequence of the floors based on the set of clusters, and allocate a floor-level identifier to at least access point based on the determined sequence.

Although a specific embodiment for a device 1100 capable of executing components and the allocation logic 1124 for implementing the functionality and embodiments suitable for carrying out the various steps, processes, methods, and operations described herein is discussed with respect to FIG. 11, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the allocation logic 1124 acts in tandem between the devices. The elements depicted in FIG. 11 may also be interchangeable with other elements of FIGS. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary”, or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network; and
a memory communicatively coupled to the processor, wherein the memory comprises an allocation logic that is configured to:
receive discovery data and signal data, wherein:
the discovery data indicates an association of a plurality of first network devices and a plurality of second network devices connected to the plurality of first network devices, the plurality of second network devices being deployed across one or more floors in a space; and
the signal data is associated with a set of second network devices of the plurality of second network devices;
classify the plurality of second network devices into a set of clusters based on the received discovery data and the received signal data;
determine a sequence of the one or more floors based on the set of clusters; and
allocate a floor-level identifier to at least one second network device of the plurality of second network devices based on the determined sequence.

2. The device of claim 1, wherein the plurality of first network devices comprises switches configured to implement at least one of a connectivity discovery protocol or a link layer discovery protocol.

3. The device of claim 1, wherein the plurality of second network devices comprises access points deployed across the one or more floors.

4. The device of claim 1, wherein the discovery data comprises at least one of connectivity discovery protocol data or link layer discovery protocol data.

5. The device of claim 1, wherein the discovery data comprises at least one of: a device name or a location identifier, of a first network device of the plurality of first network devices and a second network device of the plurality of second network devices.

6. The device of claim 1, wherein the signal data comprises received signal strength indicator data.

7. The device of claim 1, wherein a cluster of the set of clusters corresponds to a floor of the one or more floors.

8. The device of claim 1, wherein the allocation logic is further configured to determine a number of floors in the space based on a count of clusters in the set of clusters.

9. The device of claim 1, wherein the allocation logic is further configured to perform unsupervised machine learning to classify the plurality of second network devices into the set of clusters.

10. The device of claim 1, wherein, prior to determining the sequence of the one or more floors, the allocation logic is further configured to validate the set of clusters.

11. The device of claim 10, wherein the set of clusters is validated based on a variance value between the set of clusters and a variance value within the set of clusters.

12. The device of claim 1, wherein the allocation logic is further configured to transmit an indication of the floor-level identifier allocated to the at least one second network device.

13. The device of claim 1, wherein the set of clusters is connected by one or more weighted edges.

14. The device of claim 13, wherein the sequence of the one or more floors is determined based on weights of the one or more weighted edges.

15. The device of claim 1, wherein the allocation logic is further configured to:
receive new discovery data and new signal data;
update the set of clusters based on the new discovery data and the new signal data;
determine that a first count of clusters in the updated set of clusters is different from a second count of clusters in the set of clusters; and
update the sequence of the one or more floors based on the determination that the first count of clusters is different from the second count of clusters.

16. The device of claim 15, wherein the allocation logic is further configured to allocate a new floor-level identifier to the at least one second network device based on the updated sequence.

17. An access point, comprising:
a processor;
a network interface controller configured to provide access to a network; and
a memory communicatively coupled to the processor, wherein the memory comprises an allocation logic that is configured to:
transmit signal data and discovery data, wherein the discovery data indicates an association of a switch and the access point and a plurality of other access points that are deployed across one or more floors in a space; and
receive a floor-level identifier allocation based on the transmitted signal data and the transmitted discovery data.

18. The access point of claim 17, wherein the signal data comprises received signal strength indicator data associated with the plurality of other access points, and the discovery data comprises at least one of connectivity discovery protocol data or link layer discovery protocol data.

19. The access point of claim 17, wherein the access point and the plurality of other access points are connected to a set of switches that provide the discovery data.

20. A method for floor-level allocation of network devices, the method comprising:
receive discovery data and signal data, wherein:
the discovery data indicates an association of a plurality of first network devices and a plurality of second network devices connected to the plurality of first network devices, the plurality of second network devices being deployed across one or more floors in a space; and
the signal data is associated with a set of second network devices of the plurality of second network devices;
classify the plurality of second network devices into a set of clusters based on the received discovery data and the received signal data;
determine a sequence of the one or more floors based on the set of clusters; and
allocate a floor-level identifier to at least one second network device of the plurality of second network devices based on the determined sequence.
